(19) United States
(12) Patent Application Publication
(10) Pub. No.: US 2026/0081758 A1
(43) Pub. Date: Mar. 19, 2026

(54) ENCRYPTION KEY HIERARCHY FOR DATA ENCRYPTION MANAGEMENT

(71) Applicant: Rubrik, Inc., Palo Alto, CA (US)

(72) Inventors: Srinivasan P.S., Bengaluru (IN); Hao Wu, Santa Clara, CA (US); Niharika Kaushal Kabra, Bengaluru (IN); Matthew Cheung, Chicago, IL (US); Harshadrai Gajendrakumar Parekh, San Jose, CA (US); Mike Wronski, Atlanta, GA (US); Ranjana Bhadoria, Santa Clara, CA (US); Barsa Tandukar, San Jose, CA (US)

(21) Appl. No.: 18/889,074

(22) Filed: Sep. 18, 2024

(51) Int. Cl. H04L 9/08

(52) U.S. Cl. CPC H04L 9/0822

(57) ABSTRACT

Methods, systems, and devices for data management are described. A data management system (DMS) may store encrypted backup data across one or more storage locations using a hierarchical encryption key management design. The hierarchical design may include data encryption keys (DEKs) that are used to encrypt the backup data, and may also include one or more layers of key encryption keys (KEKs). For example, a root KEK may be implemented at the top of the hierarchy and may be used to encrypt intermediary KEKs, while intermediary KEKs may be implemented at one or more lower levels of the hierarchy and may be used to encrypt other intermediary KEKs and/or the DEKs, with the DEKs at the bottom of the hierarchy and used to encrypt data. In some examples, the root KEK may be wrapped by a customer master key, enabling customers of the DMS to provide their own encryption keys.

### FIELD OF TECHNOLOGY

The present disclosure relates generally to data management, including techniques for encryption key hierarchy for data encryption management.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports encryption key hierarchy for data encryption management in accordance with aspects of the present disclosure.

FIG. 2 shows an example of an encryption key hierarchy that supports encryption key hierarchy for data encryption management in accordance with aspects of the present disclosure.

FIG. 3 shows an example of a computing environment that supports encryption key hierarchy for data encryption management in accordance with aspects of the present disclosure.

FIG. 4 shows an example of a user interface (UI) that supports encryption key hierarchy for data encryption management in accordance with aspects of the present disclosure.

FIG. 5 shows an example of a UI that supports encryption key hierarchy for data encryption management in accordance with aspects of the present disclosure.

FIG. 6 shows an example of a process flow that supports encryption key hierarchy for data encryption management in accordance with aspects of the present disclosure.

FIG. 7 shows an example of a process flow that supports encryption key hierarchy for data encryption management in accordance with aspects of the present disclosure.

FIG. 8 shows an example of a process flow that supports encryption key hierarchy for data encryption management in accordance with aspects of the present disclosure.

FIG. 9 shows an example of a process flow that supports encryption key hierarchy for data encryption management in accordance with aspects of the present disclosure.

FIG. 10 shows a block diagram of an apparatus that supports encryption key hierarchy for data encryption management in accordance with aspects of the present disclosure.

FIG. 11 shows a block diagram of a DMS manager that supports encryption key hierarchy for data encryption management in accordance with aspects of the present disclosure.

FIG. 12 shows a diagram of a system including a device that supports encryption key hierarchy for data encryption management in accordance with aspects of the present disclosure.

FIGS. 13 through 16 show flowcharts illustrating methods that support encryption key hierarchy for data encryption management in accordance with aspects of the present disclosure.

### DETAILED DESCRIPTION

A data management system (DMS) may include various nodes, clusters, and sub-systems that provide backup and recovery services for customer computing systems or databases. The DMS may store backup data across multiple storage locations, such as in cloud locations and on customer premises (e.g., in one or more data centers). Backup data may be encrypted at the storage locations for compliance with security and privacy policies. Different storage locations may use different encryption keys. For compliance with security and privacy policies, encryption keys may be changed or rotated. Key rotation may refer to the periodic updating of which encryption keys are in use (e.g., may involve the creation of a new family of one or more keys), and rekeying may refer to re-encryption of an object using a new key. Both key rotation and rekeying may enhance the security of encrypted data. Data may be retrieved from multiple locations for a recovery purpose, which may involve use of multiple encryption keys across the multiple storage locations. Rekeying using updated data encryption keys (DEKs) at immutable storage locations may not be possible as such rekeying writing may involve writing data at an immutable location.

Aspects of this disclosure relate to a hierarchical encryption key management design for connected storage locations for a customer of a DMS. The hierarchical design may include DEKs that are used to encrypt the backup data, and may also include one or more layers of key encryption keys (KEKs). For example, a root KEK may be implemented at the top of the hierarchy and may be used to encrypt intermediary KEKs, while intermediary KEKs may be implemented at one or more lower levels of the hierarchy and may be used to encrypt other intermediary KEKs and/or the DEKs, with the DEKs at the bottom of the hierarchy and used to encrypt data. In some examples, the root KEK may be wrapped by a customer master key, enabling customers of the DMS to provide their own encryption keys.

To incorporate key rotation/rekeying into the hierarchical keying scheme, KEKs at an intermediary level of the key hierarchy may be rotated so that new intermediary KEKs are used and DEKs are re-encrypted with different intermediary KEKs over time. Accordingly, if a DEK or an intermediary KEK is compromised, the quantity of compromised data may be limited. Further, to enable rekeying using customer provided master keys, the root KEK may be rewrapped (e.g., re-encrypted) with a new master key. The hierarchical encryption key design thus enables rekeying across multiple storage locations without re-encryption of the stored data across the multiple storage locations. The DMS also may provide a dashboard which may provide a single view of the storage locations and key types and key management services (KMSs) used for each storage locations.

The hierarchical design may be leveraged to rekey data at an immutable storage location. For example, a root KEK for backup data may be re-encrypted using an updated master key without re-encrypting the data using updated DEKs. As the intermediary KEKs and the DEKs may be secured internally at the different storage locations, the intermediary KEKs and the DEKs may not be exposed to breach risks.

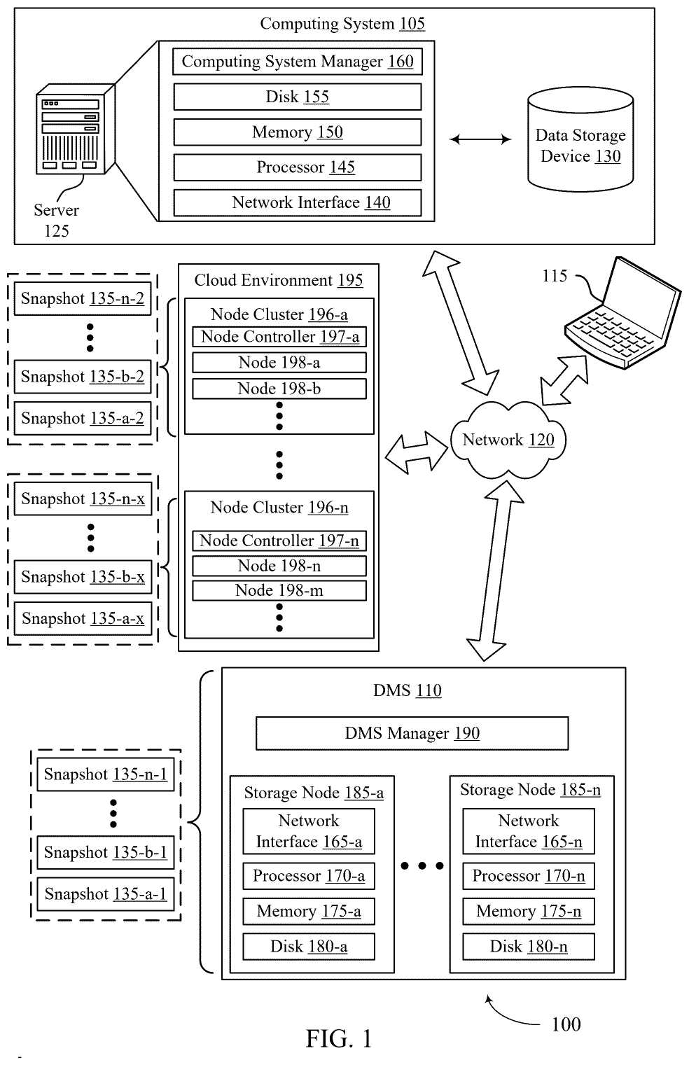

FIG. 1 illustrates an example of a computing environment 100 that supports encryption key hierarchy for data encryption management in accordance with aspects of the present disclosure. The computing environment 100 may include a computing system 105, a DMS 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructureas-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. In some cases, a computing object that is the subject of a snapshot 135 may be or include a collection of multiple objects (e.g., computing objects may have hierarchical relationships, with lower-level computing objects included within one or more higher-level computing objects). For example, a filesystem may include multiple files, and along with the filesystem being a computing object, the files therein may also be computing objects. Or, as another example, a database may include multiple tables, and along with the database being a computing object, the tables therein may also be computing objects. Thus, a snapshot may be of one or more computing objects, and a snapshot of a first computing object (e.g., a higher-level computing object) may also be a snapshot of each computing object (e.g., each lower-level computing object) that is included in (e.g., is a member or component of) the first computing object. Additionally, a snapshot may be of one or more lower-level computing objects individually (e.g., a snapshot of a lower-level computing object may be separate from another snapshot of another lower-level computing object, separate from another snapshot of a higher-level computing object that contains the lower-level computing object, or both).

A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. A base snapshot 135 may alternatively be referred to as a full snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a base snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a base snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a computing system different from the computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

The backup data (e.g., the snapshots 135) stored at the storage nodes 185 and/or the node clusters 196 may be encrypted by the DMS 110, for example, for compliance with security and privacy policies. Different storage locations may use different encryption keys and/or encryption techniques. The DMS 110 may implement key rotation and rekeying to enhance the security of encrypted backup data. As described herein, the DMS 110 may retrieve the backup data from the multiple storage locations (e.g., from the multiple storage nodes 185 or from the multiple node clusters 196) for recovery purposes, which may involve use of multiple encryption keys across the multiple storage locations. For example, the multiple storage locations may include cloud native storage locations and on-premises (e.g., customer premises) storage locations. Further, in some examples, a storage location (e.g., a node cluster 196) may be immutable (e.g., may have an activated immutability lock).

The DMS 110 may use a hierarchical encryption key management design for storage locations (e.g., for a customer of the DMS 110). The hierarchical design may include DEKs that are used to encrypt the backup data, and may also include one or more layers of KEKs. For example, a root KEK may be implemented at the top of the hierarchy and may be used to encrypt intermediary KEKs, while intermediary KEKs may be implemented at one or more lower levels of the hierarchy and may be used to encrypt other intermediary KEKs and/or the DEKs, with the DEKs at the bottom of the hierarchy and used to encrypt data. In some examples, the root KEK may be wrapped by a customer master key, enabling customers to provide their own encryption keys. For example, customers may configure master KEKs with customer managed keys (e.g., bring your own key (BYOK)) or master keys provided by the DMS 110. A centralized key management system (KMS) dashboard may be provided for customers of the DMS 110 to register various types of key vaults for data encryption. Such key vaults may include on-premises key vaults (e.g., Key Management Interoperability Protocol (KMIP) vaults) or cloud native key vaults (e.g., Azure Key vault, Amazon Web Services KMS, of Google Cloud Platform KMS). The DMS 110 may also support use of master KEKs such as passphrases, Rivest-Shamir-Adleman (RSA) keys, or hardware-based keys (e.g., trusted platform module (TPM)).

To incorporate key rotation/rekeying into the hierarchical keying scheme, KEKs at an intermediary level of the key hierarchy may be rotated so that new intermediary KEKs are used and DEKs are re-encrypted with different intermediary KEKs over time. Accordingly, if a DEK or an intermediary KEK is compromised, the quantity of compromised data may be limited. Further, to enable rekeying using customer provided master keys, the root KEK may be rewrapped with a new master key. The hierarchical encryption key design thus enables rekeying across multiple storage locations without re-encryption of the stored data across the multiple storage locations. Further, the DMS 110 may provide for fine-grained data segmentation using per data chunk/block DEKs.

The DMS 110 also may provide a dashboard (e.g., via a user interface (UI)) which may provide a single view of the storage locations and key types and KMSs used for each storage locations. For example, the dashboard may present information regarding data locations for a particular customer (e.g., all data storage locations for the particular customer). The dashboard may present information such as the encryption methods (e.g., client side encryption (CSE), ciphers (e.g., AES-GCM-256), and/or encryption master KEKs within a single UI view. A user of the dashboard may perform encryption management tasks such as rekeying or key rotation for one or multiple storage locations via the dashboard. The dashboard may display key management job statuses of each storage location (e.g., rekeying status, key rotation status, etc.).

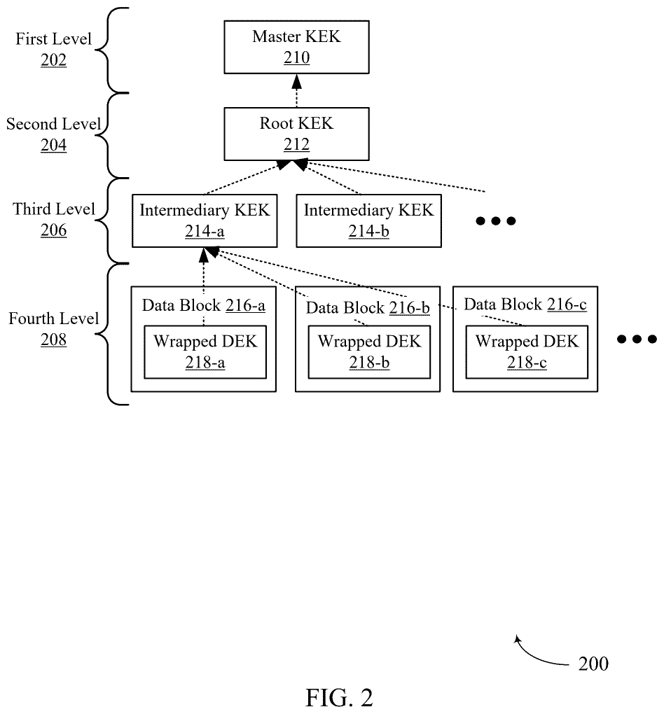

FIG. 2 shows an example of an encryption key hierarchy 200 that supports encryption key hierarchy for data encryption management in accordance with aspects of the present disclosure. The encryption key hierarchy 200 may implement or may be implemented by aspects of the computing environment 100.

As described herein, a DMS 110 may encrypt backup data for storage in one or more locations using a four level encryption key hierarchy (e.g., a first level 202, a second level 204, a third level 206, and a fourth level 208). Use of the four levels of the encryption key hierarchy 200 may enable a customer to provide the master KEK 210 and to perform rekeying via updating the master KEK 210 without re-encrypting data.

For example, the first level 202 may include the master KEK 210. The master KEK may be provided by the customer of the DMS 110 associated with the backed up data. Accordingly, the encryption key hierarchy 200 may implement BYOK. For example, the customer may manually provide a master KEK 210 (e.g., the master KEK may be a passphrase provided via a computing device 115), the DMS 110 may receive the master KEK 210 from a KMS to which the customer is subscribed and has provided access to the DMS 110, or the DMS 110 may receive the master KEK 210 from a TPM.

The second level 204 may include a root KEK 212. The master KEK 210 may wrap (e.g., may encrypt) the root KEK 212. The root KEK 212 may be a single KEK that is wrapped by the master KEK 210 (e.g., provided by a KMS of the customer), which may simplify changing the master KEK 210 or the source of the master KEK for the customer, as to change the master KEK 210, the DMS 110 may re-encrypt a single KEK, the root KEK 212. Further, as the root-KEK may be re-encrypted without re-encrypting existing data, the risk of leading the internal DEKs, intermediary KEKs, and encrypted data may be reduced.

The third level 206 may include intermediary KEKs 214. The root KEK 212 may wrap (e.g., may encrypt) the intermediary KEKs 214. The fourth level 208 may include DEKs 218. The intermediary KEKs 214 may wrap (e.g., may encrypt) the DEKs 218. Each DEK 218 may be encrypted by an intermediary KEK 214. An intermediary KEK 214 may encrypt multiple DEKs 218. For example, as shown an intermediary KEK 214-a may wrap the DEK 218-a, the DEK 218-b, and the DEK 218-c. An intermediary KEK 214-b may wrap other DEKs 218. DEKs 218 may wrap (e.g., may encrypt) data blocks 216 of the backup data (e.g., portions of the backup data). For example, the DEK 218-a may wrap the data block 216-a, the DEK 218-b may wrap the data block 216-b, and the DEK 218-c may wrap the data block 216-c. The DEKs 218 may be stored in the storage locations with the data blocks 216.

The intermediary KEKs 214 may be rotated (e.g., periodically based on time or an amount of data) such that no one intermediary KEK 214 is used to encrypt a large amount of backup data. For example, in the case that an intermediary KEK 214 or a DEK 218 is compromised or breached, the blast of the compromise or breach may be restricted. Periodic key rotation may ensure that newly obtained backup data is encrypted using new sets of intermediary KEKs 214 and DEKs 218 to obtain strong data segmentation. For example, for each new snapshot 135 the DMS 110 obtains, the DMS 110 may use a new intermediary KEK 214.

In some examples, the key hierarchy (e.g., the encryption key hierarchy) for a given storage location may be stored as a file (e.g., a key hierarchy file or a key management file) at the storage location. For example, when the DMS 110 retrieves data blocks 216 from a storage location (e.g., as part of a recovery process), the DMS 110 may retrieve the file that indicates the key hierarchy and the master KEK from the customer (e.g., from a KMS) in order to decrypt the data blocks 216. Multiple instances of data workloads may run in parallel on multiple machines (e.g., for recovery purposes or for backup purposes), and accordingly the key hierarchy may be consistent across the data workload instances (e.g., the key hierarchy may be stored in local in-memory caches of the data workload instances for fast data operations). The key hierarchy may be resilient to crashes during state transitions (e.g., for key rotation or rekeying). For example, the DMS 110 may store a state file on the storage locations which may track states of key hierarchy operations (e.g., key rotation or rekeying) and the DMS 110 may back up key hierarchy files before initiating state transitions. Such transitions may be idempotent and crashes during state transitions may be recovered based on the state tracking file and re-attempts at the state transitions. For example, if a state transition fails, the DMS 110 may revert to a backed up key hierarchy file.

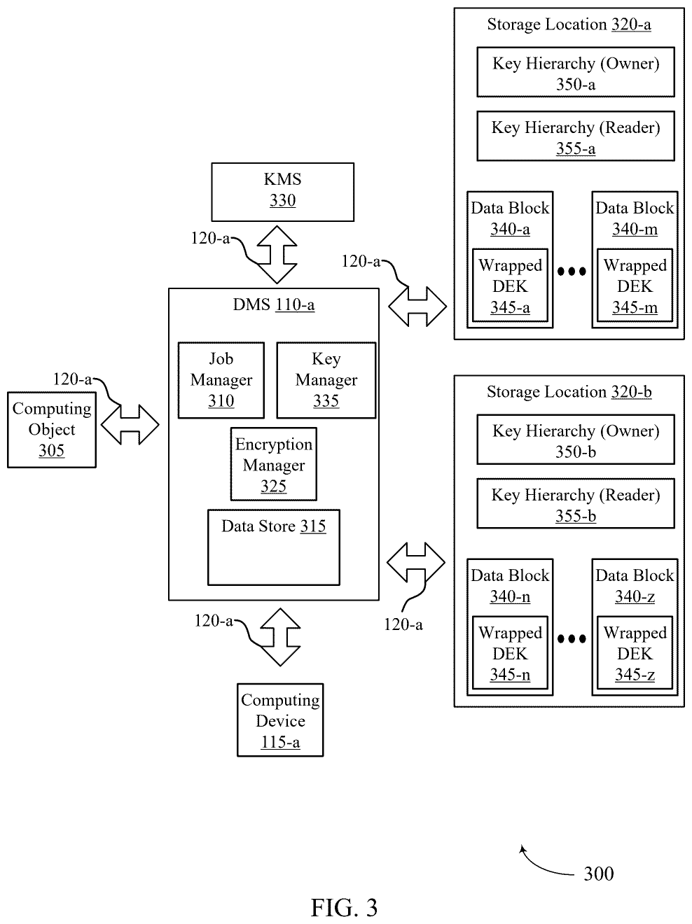

FIG. 3 shows an example of a computing environment 300 that supports encryption key hierarchy for data encryption management in accordance with aspects of the present disclosure. The computing environment 300 may implement or may be implemented by aspects of the computing environment 100 or the encryption key hierarchy. For example, the computing environment 300 includes a DMS 110-a, which may be an example of a DMS 110 as described herein.

The DMS 110-a may provide a backup and recovery services for the computing object 305 (e.g., or one or more computing objects 305 associated with a customer of the DMS 110-a). For example, the computing object 305 may be an example of the computing system 105 or a portion of the computing system 105 as described herein. For example, the DMS 110-a may include a job manager 310 which may schedule and manage backup and recovery operations for the computing object 305. For example, the DMS 110-a may obtain snapshots 135 of the computing object via the network 120-a, which may be an example of the network 120 as described herein. The DMS 110-a may store the backup data at one or more storage locations 320. For example, the DMS 110-a may send the backup data to the one or more storage locations 320 via the network 120-a. For example, the storage locations 320 may be examples of node clusters 196 as described herein. Each storage location may include one or more node clusters 196 as described herein.

The DMS 110-a may encrypt the backup data prior to storing the backup data in the storage locations 320. For example, the DMS 110-a may store the backup data in the data store 315 (e.g., storage nodes 185) and may encrypt the data in the data store 315 using an encryption manager 325. Each storage location 320 (e.g., the storage location 320-a and the storage location 320-b) may have a respective set of encryption parameters (e.g., key/cipher types, root KEKs, amount of data per block, or KMS). The key manager 335 may store encryption parameters for the different storage locations. Prior to storing the backup data in a given storage location 320, the DMS 110-a (e.g., the encryption manager 325) may encrypt the backup data in accordance with the encryption parameters.

As described herein, the DMS 110-a may encrypt the backup data in accordance with a four level encryption key hierarchy (e.g., the encryption key hierarchy 200 as described with reference to FIG. 2). For example, the DMS 110-a may receive a master KEK from a customer (e.g., such as a passphrase), for example, via a computing device 115-a associated with the customer account (e.g., via the network 120-a). As another example, the customer may subscribe to a KMS 330 which may provide encryption keys, and the customer may provide access to the DMS 110-a for the KMS 330. The DMS 110-a may receive the master KEK from the KMS 330 (e.g., via the network 120-a).

For example, the DMS 110-a may encrypt data blocks 340 of backup data obtained from the computing object 305 using DEKs for the storage location 320-a. The DMS 110-a may encrypt the DEKs for the storage location 320-a using the intermediary KEKs for the storage location 320-a. The DMS 110-a may encrypt intermediary KEKs for the storage location 320-a using the root KEK for the storage location 320-a. The DMS 110-a may encrypt the root KEK the storage location 320-a using the master KEK for the storage location 320-a. The DMS 110-a may store an indication of the encryption key hierarchy for the storage location 320-a in a key hierarchy file 350-a at the storage location 320-a. The encrypted DEK 345 for each data block may be stored at the storage location with each respective data block (e.g., the encrypted DEK 345-a with the data block 340-a,. the encrypted DEK 345-m with the data block 340-m). Accordingly, when the DMS 110-a retrieves the data blocks 340 from the storage location 320-a, the DMS 110-a may retrieve the encryption key hierarchy from the key hierarchy file 350 in order to decrypt the data blocks 340.

Similarly, The DMS 110-a may encrypt data blocks 340 of backup data obtained from the computing object 305 using DEKs for the storage location 320-b. The DMS 110-a DMS 110-a may encrypt the DEKs for the storage location 320-b using the intermediary KEKs for the storage location 320-b. The DMS 110-a may encrypt intermediary KEKs for the storage location 320-b using the root KEK for the storage location 320-b. The DMS 110-a may encrypt the root KEK the storage location 320-b using the master KEK for the storage location 320-b. The DMS 110-a may store an indication of the KEK hierarchy for the storage location 320-b in a key hierarchy file 350-b at the storage location 320-b. The encrypted DEK 345 for each data block may be stored at the storage location with each respective data block (e.g., the encrypted DEK 345-n with the data block 340-n, . . . , the encrypted DEK 345-z with the data block 340-z). Accordingly, when the DMS 110-a retrieves the data blocks 340 from the storage location 320-a, the DMS 110-a may retrieve the encryption key hierarchy from the key hierarchy file 350 in order to decrypt the data blocks 340. In some examples, the key manager 335 may store the encryption key hierarchy for each storage location (e.g., for the storage location 320-a and the storage location 320-b).

In some examples, the DMS 110-a may support key rotation for intermediary KEKs. For example, support key rotation for intermediary KEKs may refer to the process of creating new intermediary KEKs with read and write permissions which are used for generating/encrypting DEKs going forward. Once a new intermediary KEK is created for a storage location 320, the existing intermediary KEKs for the storage location 320 may be marked as read-only (e.g., may be used for unwrapping/decrypting existing DEKs and may not be used for wrapping/encrypting new DEKs). For example, to rotate an intermediary KEK for a storage location 320, the DMS 110-a may acquire a semaphore to verify that no two key hierarchy operations run in parallel on the same key hierarchy in a storage location (e.g., to avoid simultaneous rekeying and key rotation). For example, the semaphore may be an atomic file based lock on the storage location 320. The DMS 110-a may obtain the key hierarchy file 350 for the storage location 320 and may create a new intermediary KEK in the key hierarchy file. The DMS 110-a may update the hierarchy in the key hierarchy file 350 for the storage location and may lock the key hierarchy file 350 to prevent race conditions in write operations (e.g., writing data blocks 340 to the storage location 320). Once the key hierarchy file 350 is updated at the storage location 320, all users of the location may receive the updated keys (e.g., the updated key hierarchy) within an update duration.

For example, different users or accounts associated with a customer may have different permissions for each storage location 320. For example, an owner account may have read/write permissions (e.g., to both store data to the storage location 320 during a backup process and retrieve data from the storage location 320 during a restore process). A reader account may have read permissions (e.g., to retrieve data from the storage location 320 during a restore process). Different owner accounts may have separate key hierarchy files for the storage location, and similarly different reader accounts may have secondary key hierarchy files 355 which may be used to decrypt retrieved data. For example, the storage location 320-a may include a secondary key hierarchy file 355-a associated with a reader account for the storage location 320-a, and the storage location 320-b may include a secondary key hierarchy file 355-b associated with a reader account for the storage location 320-b. Based on an owner account updating the key hierarchy in the key hierarchy file 350 for a storage location, the secondary key hierarchy files 355 for the reader accounts may be updated and/or other key hierarchy files 350 for other owner accounts may be updated. For example, a time to live (TTL) of the key hierarchy update based on a key rotation may be maintained by the DMS 110-a in local in-memory cache of the DMS 110-a. Within TTL+delta time, the key hierarchy files for each of the users of the key hierarchy may be updated to indicate the updated key hierarchy, and accordingly other owner users may begin to use to the new intermediary KEK created by the key rotation operation.

In some examples, the DMS 110-a may support master KEK rekeying, which may refer to the process of changing the master KEK associated key hierarchy for protecting a particular data workload (e.g., stored on the one or more storage locations 320). For example, the master KEK rekeying may involve updating the pointer to a customer managed KMS 330 or a new plaintext RSA key. For example, to begin a rekey operation for a storage location 320, the DMS 110-a may acquire a semaphore to verify that no two key hierarchy operations run in parallel on the same key hierarchy in a storage location 320 (e.g., to avoid simultaneous rekeying and key rotation). The DMS 110-a may store (e.g., in the key manager 335 or at the storage location 320) a record of the prior master KEK associated with the storage location (e.g., in order to recover in the event of a rekeying failure). The DMS 110-a may obtain the key hierarchy from the key hierarchy file 350 and may re-encrypt the root KEK with the updated master KEK. The DMS 110-a may update the hierarchy in the key hierarchy file 350 for the storage location and may lock the key hierarchy file 350 to prevent race conditions in write operations (e.g., writing data blocks 340 to the storage location 320). Once the key hierarchy file 350 is updated at the storage location 320, all users of the location may receive the updated keys (e.g., the updated key hierarchy) within an update duration.

Users of the key hierarchy from the local cache may continue to work with the same key hierarchy as the root KEK, intermediary KEKs, and DEKs may not change. All other users of the storage location may receive the updated encryption key hierarchy within the TTL+delta time as described with reference to the key rotation operation.

As described herein, the DMS 110-a may support different users or accounts of a customer, including owner accounts and reader accounts. An owner account for a storage location 320 may have read and write permissions for the storage location 320 (e.g., for a cloud storage location). A reader account for a storage location 320 may have read-only permissions for the storage location 320 (e.g., for a cloud storage location) that is written by an owner account. In order to support reader and owner accounts with unified encryption key management, the key hierarchy may be written to the cloud storage at an owner account location (e.g., in the key hierarchy file 350). The entire key hierarchy in the key hierarchy file 350 may be encrypted using the master KEK that the owner account provided (e.g., via the computing device 115-a or the KMS 330). When a reader account attempts to access the data on the storage location, the reader account may provide a master KEK. Accordingly, the reader account may be validated based on whether the reader account provided master KEK successfully decrypts the key hierarchy stored at the storage location.

As described herein, the owner account may modify the master KEK of the four-level key hierarchy for the storage location 320 via a rekey operation. In such cases, the reader account may lose access to unwrapping the four-level encryption key hierarchy and may subsequently fail to decrypt and read data files in the data blocks 340. The DMS 110-a may implement techniques to update the reader accounts with the updated master KEKs after rekeying. For example, the storage location 320 may include metadata indicating a pointer to a master KEK source, and the owner account may update the metadata indicating the update the master KEK source based on completion of a master KEK rekey.

For example, in a DMS 110-a orchestrated master KEK update, the DMS 110-a may track the reader accounts that are derived from a particular owner account (e.g., the secondary key hierarchy files 355 that track a key hierarchy file 350 associated with an owner account). Based on the successful completion of a rekey operation, the DMS 110-a may query all reader accounts and may push the updated master key association to the reader accounts (e.g., to the secondary key hierarchy files 355 associated with the affected reader accounts).

As another example, a customer of the DMS 110-a may update the key version of the master KEK when using an external KMS such as the KMS 330. The key version may be stored in the storage location in an unencrypted format, and accordingly the reader accounts may fetch the key version even if the master KEK is out of date (e.g., has been updated via a rekey operation). Accordingly, if a reader account is unable to unwrap the four-level key hierarchy indicated in the secondary key hierarchy file 355, the reader account may read the key version from the storage location 320. If new key version enables the reader account to decrypt the four-level hierarchy, the reader account may use the new key version going forward. For example, the reader account may use the key version to obtain the updated master KEK from the KMS 330 (e.g., based on the key ID for the master KEK which may be stored in the secondary key hierarchy file 355).

As another example, the user of a reader account may manually input the updated master KEK in order to decrypt the four-level hierarchy, and the reader account may use the updated master KEK going forward to decrypt the four-level hierarchy.

Accordingly, based on completion of a rekey operation, the different accounts may be updated with the rekey operation to prevent disruption of backup and recovery workflows. For example, reader account clients may read metadata indicating the master KEK has been updated, and accordingly reader account clients may read the metadata indicating the master KEK has been updated and may update master KEK configurations accordingly, as described herein (e.g., via the user associated with the reader account providing an updated master KEK or via acquiring the updated master KEK from a KMS 330 based on the updated metadata (e.g., the version ID)).

In some examples, a storage location, for example, the storage location 320-a, may be an immutable archival location. Immutable archival locations may store large volumes of data, and thus solutions that re-encrypt data as part of a rekey operation may be impractical. Further, data immutability of immutable archive locations may prevent rekey solutions from erasing data encrypted by old DEKs, thereby presenting a potential security risk.

Use of a four-level encryption hierarchy as described herein may support rekeying via rekeying the master key (e.g., updating the root KEK) for an immutable storage location without re-encrypting the data at the immutable archival locations. A described herein, updated master KEKs may be pushed across encryption clients (e.g., owner and reader accounts of the DMS 110-a for the storage locations 320) such that backup and recovery workflows are not disrupted.

For example, the DEK of each file (e.g., each data block 340) may serve as the signing key (e.g., replacing static signing key methods) such that the file version metadata signing key may be rotated per data file (e.g., each DEK may encrypt a file or a data block 340). As described herein, each DEK may be encrypted via an intermediary KEK, and each intermediary KEK may be encrypted via a root KEK, such as via AES-GCM-256 which may guarantee both confidentiality and integrity. Accordingly, integrity of the encryption may be rooted to a rekeyable master KEK. The unencrypted DEKs and internal KEKs (e.g., the intermediary KEKs and root KEKs) may be secured internally and may not be exposed (e.g., may not be transmitted between the DMS 110-a and the storage location). For example, the DEKs and internal KEKs may be encrypted prior to transmission between the DMS 110-a and the storage location. Thus, the ability to rekey the master KEK may mitigate the risk of breach of a master KEK.

The DMS 110-a may leverage cloud native immutability for files to implement immutable archival files (e.g., data blocks 340 may be immutable on a storage location 320). For example, file versions that are uploaded to a storage location may be tagged with a key-value metadata that contains validation metadata holding the following information: a timestamp; a key name; a signature; and an encrypted DEK (e.g., encrypted by an intermediary KEK as described herein). The signature may be derived from the timestamp and key name using a plaintext DEK generated from a KMS 330. The encrypted DEK may be used to validate the signature and the validity of the file version. The DMS 110-a may use a validation process may to determine validity of file version.

At a first step of the validation process, the DMS 110-a may iterate though each available version of a data block 340. If a version does not have a corresponding metadata file with: a timestamp; a key name; a signature; and an encrypted DEK, the DMS 110-a may determine that the version is not valid. If the version does have: a timestamp; a key name; a signature; and an encrypted DEK, at a second step of the validation process the DMS 110-a may determine if the signature is valid via decrypting the encrypted DEK through key management (e.g., via a KMS 330) and regenerating the signature. The DMS 110-a may determine that the signature is valid if the regenerated signature matches the signature in the metadata file (e.g., otherwise the signature is not valid). At a third step of the validation process, the DMS 110-a may select the version of the data block 340 with the latest metadata timestamp. If two versions have the same metadata timestamp, the DMS 110-a may select the version with the oldest cloud native timestamp. The DEK as a signing key may not be replaced by external attackers as the DEK may be encrypted by the internal KEK hierarchy via an AES-GCM-256 cipher, which guarantees integrity of the DEK. The internal KEK hierarchy may be encrypted by a master KEK as described herein, protecting the integrity of the KEK hierarchy. In some examples, asymmetric keys may be used as a master KEK, in which case the DMS 110-a may sign and encrypt such that the root KEK wrapped by the RSA key (e.g., the master KEK) is confidential and trusted. In some examples, symmetric keys may be used as a master KEK, in which case the DMS 110-a may use AES-GCM-256 to ensure both confidentiality and integrity.

In some examples, the DMS 110-a may support crash protection for the key hierarchy metadata. For example, the DMS 110-a may support overwrite operations to backup, write, and validate in an overwrite operation, such that the DMS 110-a may recover the key hierarchy right in the event of corruption to the key hierarchy. The DMS 110-a may create key hierarchy replicas (or backups) before operations such as rekey or key rotation to provide additional protection in the event the operations fail. There DMS 110-a may also periodically back up the key hierarchy to provide more granular recovery points.

As described herein, encryption key management details for data stored in a given storage location 320 may be stored in the storage location 320. When an update occurs to the encryption key hierarchy for a given storage location 320, the update may be written to the storage location. (e.g., to the key hierarchy file 350). To keep the key hierarchy file 350 updated, writes to the key hierarchy file 350 for a storage location 320 (e.g., for updates to the encryption key hierarchy) may be broken into a backup phase and a write phase.

In a first step of the backup phase, the DMS 110-a may check if a key hierarchy file 350 already exists for the storage location 320. If a key hierarchy file 350 does not exist, the DMS 110-a may proceed to the write phase. If a key hierarchy file 350 does already exist at the storage location 320, at a second step the DMS 110-a may read back the current key hierarchy file 350 for backup. At a third step, the DMS 110-a may copy the existing key hierarchy file 350 to a backup file. At a fourth step, the DMS 110-a may perform a checksum between the read values at the second and third steps. If the checksum fails, the DMS 110-a may delete the backup file and may repeat performance of steps 1 -4 until out of retries (e.g., a threshold quantity of retries is reached). If the DMS 110-a is out of retries, the DMS 110-a may delete the backup file and may indicate a failure to an administrator account associated with the customer of the DMS 110-a. If the checksum passes at the fourth step, the DMS 110-a may continue to the write phase. The backup file path may be: <file_name>_<timestamp>_<uuid>. The timestamp may provide the general order of when backups were created and the uuid may provide a unique back up file path if there is a collision caused by a time skew.

In a first step of the write phase, the DMS 110-a may write the new data to the key hierarchy file 350. At a second step of the write phase, the DMS 110-a may read back the data from the key hierarchy file 350 and may perform a checksum of the read back data to the written data. If the checksum fails at the second step, the DMS 110-a may perform steps 1 -2 until out of retries (e.g., a threshold quantity of retries is reached). If the DMS 110-a is out of retries, the DMS 110-a may copy the backup file of the key hierarchy file 350 created at the backup phase (if one exists) to the key hierarchy file 350 and may perform a checksum. If no backup file of the key hierarchy file 350 exists (e.g., the key hierarchy file 350 did not exist previously), the DMS 110-a may delete the key hierarchy file 350. If the recovery fails (e.g., based on the checksum of the backup file), the DMS 110-a may throw a corruption error (e.g., may indicate the error to an administrator account associated with the customer of the DMS 110-a). If the recovery does not fail (e.g., based on the checksum of the backup file), the DMS 110-a may indicate a write error (e.g., to an administrator account associated with the customer of the DMS 110-a. If the checksum at the second step succeeds, the DMS 110-a may determine that the write is successful.

The DMS 110-a may store a threshold quantity (e.g., five) backups of the key hierarchy file 350 before garbage collection may begin. For example, the latest 5 backups of the key hierarchy file 350 may be kept in a garbage collection of the DMS 110-a. For example, the garbage collection may keep a list of the key hierarchy files 350 with a prefix operation and may delete all backup files besides the latest five key hierarchy files 350.

The backup phase may guarantee that the key hierarchy file 350 is unmodified on a failure. During the write phase, there may not be a guarantee that the key hierarchy file 350 is unmodified based on a failure (e.g., as the key hierarchy file 350 may revert to an earlier version based on a failure). If recovery to a previous state succeeds after a write failure, the key hierarchy file 350 may be the same as a prior version. If the recovery to a previous state fails, the key hierarchy file 350 may be in an inconsistent state (e.g., an error state).

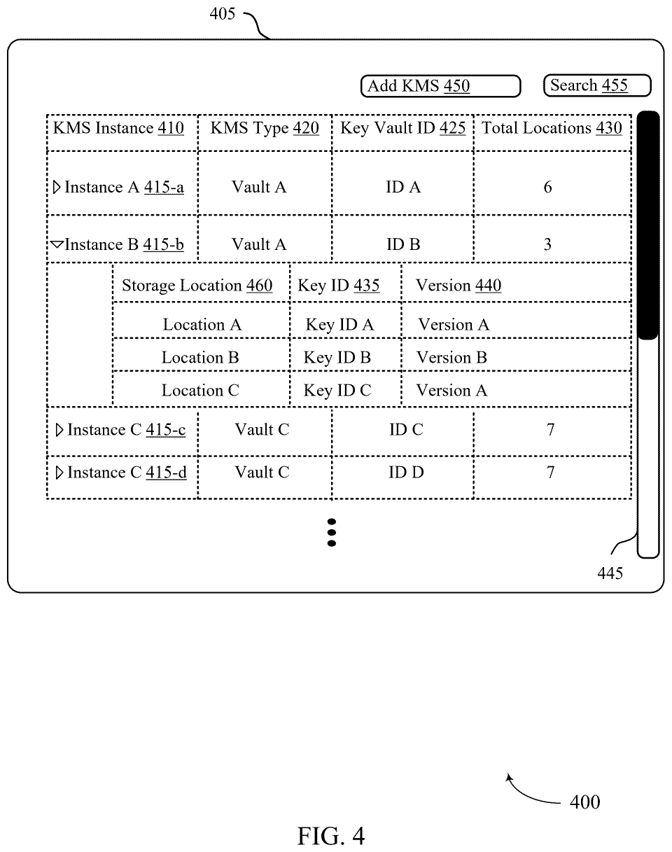

FIG. 4 shows an example of a UI 400 that supports encryption key hierarchy for data encryption management in accordance with aspects of the present disclosure. The UI 400 may implement or may be implemented by aspects of the computing environment 100, the encryption key hierarchy 200, or the computing environment 300. For example, the UI 400 may be displayed on a computing device 115 or a computing device 115-a as described herein. The UI 400 may provide a dashboard 405 for BYOK for a customer of a DMS 110.

For example, the dashboard 405 may be a centralized dashboard for the customer which may be used to add and manage KMSs (e.g., KMSs 330) within a single table/view. User accounts associated with the customer with sufficient permissions may configure KMSs and add them to the dashboard 405, which may then be used to provide master KEKs to storage locations. A user account associated with the customer may use the dashboard to provide access to the KMSs to the DMS 110. The dashboard 405 may provide a concise view of KMS key vaults owned by the customer, protected with permissions regarding which user accounts associated with the customer may view or manage which KMS key vaults. The dashboard 405 may provide a view of the associated data workloads protected by each key vault and the details of the key from the key vault that protect each workload/storage location. The dashboard 405 may present and/or enable scheduling of health checks (e.g., periodic health checks) for each KMS key vault to provide for proactive identification and alerts of faults.

For example, the dashboard 405 may include a KMS instance column 410 which may list KMS instances 415 associated with the customer (e.g., a KMS instance 415-a, a KMS instance 415-b, a KMS instance 415-c, and a KMS instance 415-d). The customer may select a KMS instance 415 on the dashboard 405 (e.g., the KMS instance 415-b is shown as selected) to view expanded information regarding the selected KMS instance 415. A KMS type column 420 may indicate the type of KMS key vault, a vault ID column 425 may indicate the ID for the KMS instance, and a total locations column 430 may indicate the quantity of storage locations (e.g., storage locations 320) of the customer are encrypted using the KMS instance. The expanded information for the selected KMS instance (e.g., the KMS instance 415-b) may include a storage location column 460 indicating the storage locations (e.g., the storage locations 320) encrypted using the KMS instance. The expanded information for the selected KMS instance (e.g., the KMS instance 415-b) may include a key ID column 435 and a key version column 440, indicating an identifier and version at the KMS instance for the master KEK that encrypts the root KEK for the corresponding storage location. For example, the root KEK for storage location A is encrypted using a master KEK that has key ID A and version A at the KMS instance 415-b. Accordingly, a user with access to the KMS instance 415-b could retrieve the master KEK that encrypts the root KEK for the storage location A from the KMS instance 415-b based on the key ID A and the version A.

As another example, the root KEK for storage location B is encrypted using a master KEK that has key ID B and version B at the KMS instance 415-b. As another example, the root KEK for storage location C is encrypted using a master KEK that has key ID C and version A at the KMS instance 415-b.

The dashboard 405 may include a scroll bar 445 to scroll through the KMS instances 415 associated with the customer. The dashboard 405 may include an add field 450 to add a KMS instance 415. The dashboard 405 may include a search field 455 to search for a particular KMS instance.

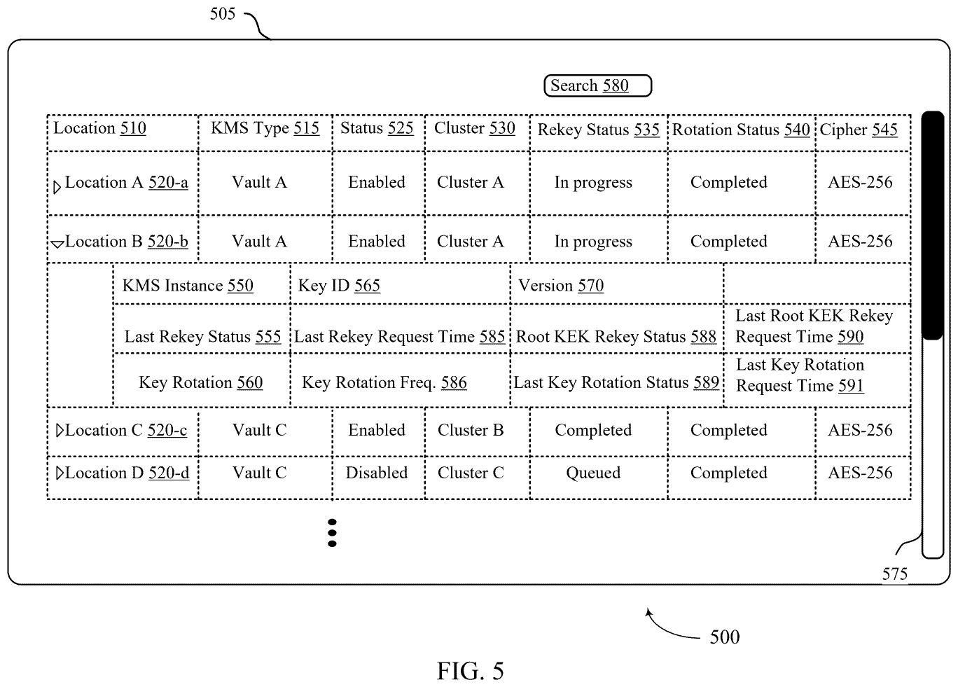

FIG. 5 shows an example of a UI 500 that supports encryption key hierarchy for data encryption management in accordance with aspects of the present disclosure. The UI 500 may implement or may be implemented by aspects of the computing environment 100, the encryption key hierarchy 200, or the computing environment 300. For example, the UI 500 may be displayed on a computing device 115 or a computing device 115-a as described herein. The UI 500 may provide a dashboard 505 for archival encryption for a customer of a DMS 110.

For example, the dashboard 505 may be a centralized dashboard for the customer which may be used to manage and view encryption information relating to the storage locations associated with the customer. For example, the dashboard 505 may include a location column 510 which may indicate the storage locations 520 (e.g., a storage location 520-a, a storage location 520-b, a storage location 520-c, and a storage location 520-d) associated with the customer (e.g., at which backup data for the customer is stored). For example, the storage locations 520 may be examples of storage locations 320 as described herein. The customer may select a storage location 520 (e.g., the storage location 520-b is shown as selected) to view expanded information regarding the selected storage location 520. The dashboard 505 may include a KMS type column 515 which may indicate a KMS vault type used to provide the master KEK for each of the storage locations 520. The dashboard 505 may include a status column 525 which may indicate a status (e.g., enabled/disabled) for each of the storage locations 520. The dashboard 505 may include a cluster column 530 which may indicate a storage cluster (e.g., a node cluster 196 as described herein) at which each of the storage locations 520 are located. The dashboard 505 may include a KMS type column 515 which may indicate a KMS vault type used to provide the master KEK for each of the storage locations 520. The dashboard 505 may include a rekey status column 535 which may indicate a status (e.g., completed, in progress, scheduled, queued) for each of the storage locations 520. The dashboard 505 may include a key rotation column 540 which may indicate a status (e.g., completed, in progress, scheduled, queued) for each of the storage locations 520. The dashboard 505 may include a cipher column 545 which may indicate a cipher type (e.g., AES-256) for each of the storage locations 520.

The expanded information for the selected storage location 520 (e.g., the storage location 320-b) may include information such as: a KMS instance field 550 which indicates the KMS instance that provides the master KEK for the storage location 520; a master KEK rekey status field 555 indicating a master KEK rekey status (e.g., queued, scheduled, complete, or in progress); a key rotation scheduling status field 560 (e.g., automated, manual); a key ID field 565 and a key version field 570 indicating an identifier and version at the KMS instance for the master KEK that encrypts the root KEK for the corresponding storage location 520; a master KEK rekey request time field 585 indicating a time a last master KEK rekey was requested; a master KEK rotation frequency field 586; a root KEK rekey status field 588 indicating a root KEK rekey status (e.g., queued, scheduled, complete, or in progress); a key rotation status field 589 (e.g., queued, scheduled, complete, or in progress); a master KEK rekey request time field 590 indicating a time a last root KEK rekey was requested; and/or a last key rotation request time field 591 indicating a time a last key rotation was requested. Each row of the dashboard 505 may include mutation functionality, which may include rekey and reader key updates as shown.

The dashboard 505 may include a scroll bar 575 to scroll through the storage locations 520 associated with the customer. The dashboard 505 may include a search field 580 to search for a particular storage location 520.

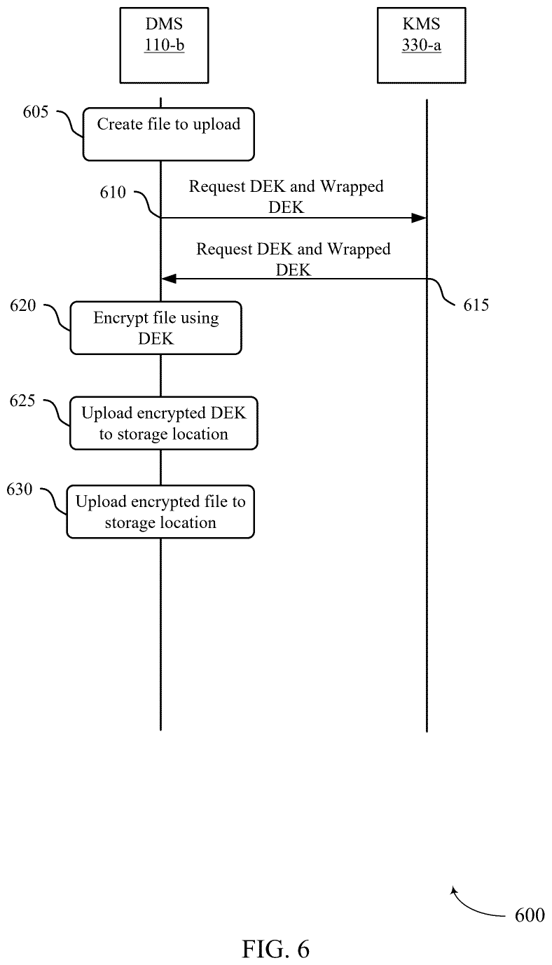

FIG. 6 shows an example of a process flow 600 that supports encryption key hierarchy for data encryption management in accordance with aspects of the present disclosure. The process flow 600 may implement or may be implemented by one or more aspects of the computing environment 100, the encryption key hierarchy, or the computing environment 300. For example, the process flow 600 may include a DMS 110-b and a KMS 330-a, which may be examples of a DMS 110 and a KMS 330 as described herein. In the following description of the process flow 600, operations between the DMS 110-b and the KMS 330-a may be added, omitted, or performed in a different order (with respect to the exemplary order shown).

The process flow 600 may show an example process for uploading backup data to a storage location (e.g., a cloud archive location). The DMS 110-b may rely on the KMS 330-a to provide DEKs to encrypt data, where the customer of the DMS 110-b associated with the backup data may indicate the KMS 330-a to use to store the backup data at a given storage location.

At 605, the DMS 110-b may create a data file (e.g., a data. txt file) locally at the DMS 110-b (e.g., in memory cache of the DMS 110-b) to upload to a storage location (e.g., a storage location 320 as described herein). The data file may include backup data obtained by the DMS 110-b for a computing object associated with the customer.

At 610, the DMS 110-b may send a request to the KMS 330-a for a DEK and an encrypted DEK.

At 615, the KMS 330-a may provide the requested DEK and an encrypted DEK to the DMS 110-b.

At 620, the DMS 110-b may encrypt the data file using (e.g., with) the provided DEK. For example, the DMS 110-b may use AES-GCM along with the plaintext DEK to encrypt the data file. The DMS 110-b may also generate a metadata file that may include the encrypted DEK, encryption metadata, and a metadata file signature generated through the plaintext DEK.

At 625, the DMS 110-b may upload the encrypted DEK (e.g., as the metadata file) to the storage location. For example, the At 630, the DMS 110-b may upload the encrypted DEK as a data.txt.rnem file. At 630, the DMS 110-b may upload the encrypted data fie to the storage location. A unique suffix may be appended to the data file path to preserve a unique mapping of the date file to the metadata file.

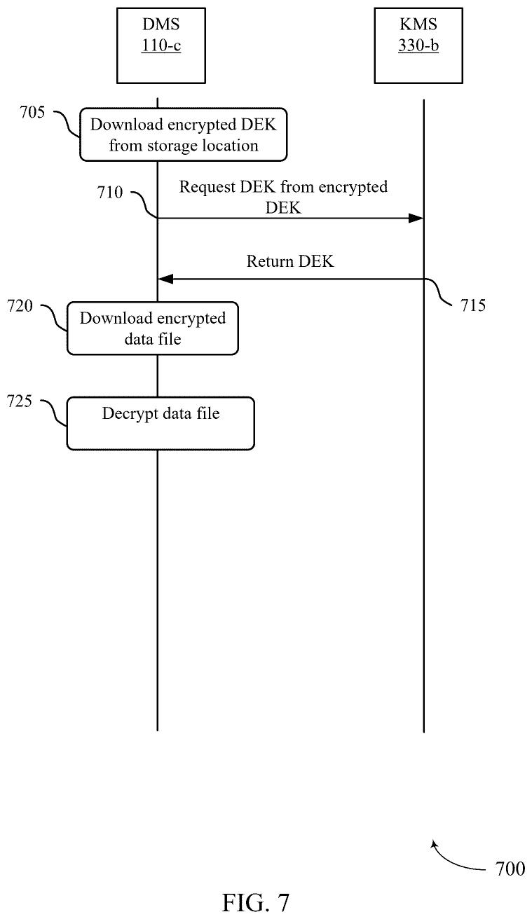

FIG. 7 shows an example of a process flow 700 that supports encryption key hierarchy for data encryption management in accordance with aspects of the present disclosure. The process flow 700 may implement or may be implemented by one or more aspects of the computing environment 100, the encryption key hierarchy, or the computing environment 300. For example, the process flow 600 may include a DMS 110-c and a KMS 330-b, which may be examples of a DMS 110 and a KMS 330 as described herein. In the following description of the process flow 700, operations between the DMS 110-c and the KMS 330-b may be added, omitted, or performed in a different order (with respect to the exemplary order shown).

The process flow 700 may show an example process for downloading backup data from a storage location (e.g., a cloud archive location), for example, as part of a restore operations. The DMS 110-c may rely on the KMS 330-b to provide DEKs to decrypt data, where the customer of the DMS 110-c associated with the backup data may indicate the KMS 330-b to use to store the backup data at a given storage location.

At 705, the DMS 110-c may download a metadata file (e.g., a data.txt.rnem file) from a storage location. The metadata file may indicate an encrypted DEK for a data file.

At 710, the DMS 110-c may request the KMS 330-b to decrypt the DEK from the encrypted DEK.

At 715, the KMS 330-b may provide the decrypted DEK to the DMS 110-c.

At 720, the DMS 110-c may download the encrypted data file from the storage location.

At 725, the DMS 110-c may decrypt the data file using the decrypted DEK provided by the KMS 330-b.

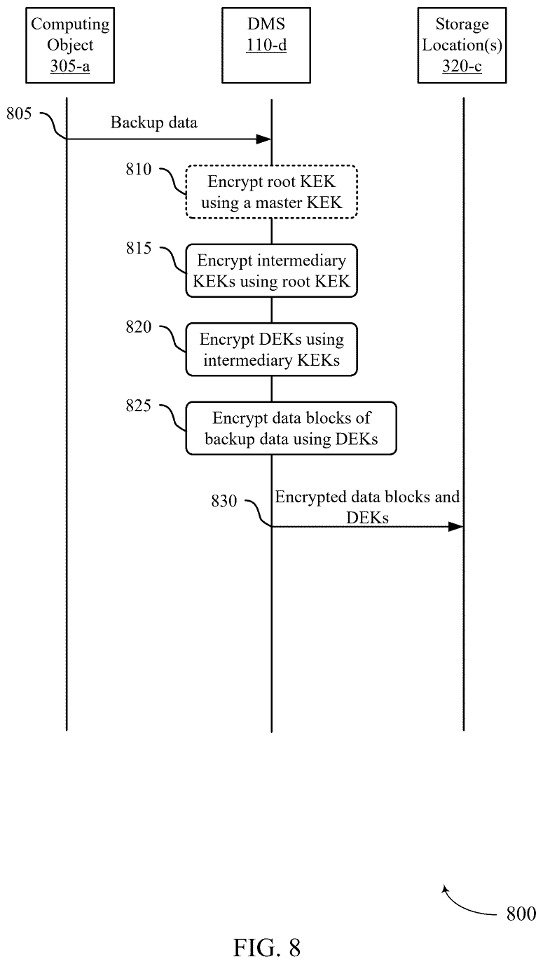

FIG. 8 shows an example of a process flow 800 that supports encryption key hierarchy for data encryption management in accordance with aspects of the present disclosure. The process flow 800 may implement or may be implemented by one or more aspects of the computing environment 100, the encryption key hierarchy, or the computing environment 300. For example, the process flow 800 may include a DMS 110-d, which may be an example of a DMS 110 as described herein. The process flow 800 may include a computing object 305-a, which may be an example of a computing object 305 as described herein. The process flow 800 may include one or more storage locations 320-c, which may be an example of a storage locations 320 as described herein. In the following description of the process flow 800, operations between the DMS 110-d, the computing object 305-a, and the one or more storage locations 320-c may be added, omitted, or performed in a different order (with respect to the exemplary order shown).

At 805, the DMS 110-d may obtain backup data from the computing object 305-a.

In some examples, at 810, the DMS 110-d may encrypt a root KEK using (e.g., with) a master KEK. In some examples, the DMS 110-d may receive, from a computing device associated with a customer account associated with the one or more computing objects, the master KEK. For example, the customer may provide the master KEK as a passphrase. In some examples, the DMS 110-d may receive the master KEK from a KMS (e.g., a KMS 330 to which the customer is subscribed and has provided access to the DMS 110-d, such as via the dashboard 405 as described herein).

At 815, the DMS 110-d may encrypt a first intermediary KEK and a second intermediary KEK using the root KEK.

At 820 , the DMS 110-d may encrypt a first DEK using the first intermediary KEK and a second DEK using the second intermediary KEK.

At 825, the DMS 110-d may encrypt a first set of data blocks using the first DEK and a second set of data blocks using the second DEK. The backup data obtained at 805 may include the first set of data blocks and the second set of data blocks.

At 830, the DMS 110-d may store the encrypted first set of data blocks along with the encrypted first DEK and the encrypted second set of data blocks along with the encrypted second DEK in the one or more storage locations 320-c.

In some examples, the DMS 110-d may receive an indication of an updated master KEK (e.g., after encrypting the root KEK). For example, a customer may periodically update the master KEK. For example, the indication of the updated master KEK may be received from a computing device associated with a customer account (e.g., the customer may provide an updated passphrase to use as the new master KEK). As another example, a KMS may provide an updated master KEK. The DMS 110-d may encrypt the root KEK with the updated master KEK.

In some examples, the DMS 110-d may store, in a key management file accessible to the DMS 110-d, an indication of a key hierarchy associated with the backup data, where the key hierarchy may indicate the master KEK, the root KEK, the first intermediary KEK, the second DEK, the first DEK, and the second DEK. For example, the key management file may be stored at the one or more storage locations 320-c or locally at the DMS 110-d. In some examples, the key hierarchy may not store the master KEK itself (e.g., a KMS or the customer may store the master KEK and the DMS 110-d may store the source of the master KEK). In some examples, the key management file may include a pointer to the master KEK or information from which the customer may identify the master KEK (e.g., a KMS instance, a version, and a master KEK identifier). In some examples, the DMS 110-d may cause display, on a UI associated with an administrator account of the DMS 110-d, of an indication of the key hierarchy (e.g., based on the key management file). In some examples, the display may indicate associations between data KEKs and intermediary KEKs and respective storage locations of the one or more storage locations.

In some examples, the DMS 110-d may obtain additional backup data associated with the computing object 305-a after obtaining the backup data. The DMS 110-d may encrypt a third intermediary KEK using the root KEK. The DMS 110-d may encrypt a third intermediary KEK using the root KEK. The DMS 110-d may encrypt a third DEK using the third intermediary KEK. The DMS 110-d may encrypt a third set of data blocks of the additional backup data using the third DEK. The DMS 110-d may store the encrypted third set of data blocks along with the encrypted third DEK in the one or more storage locations 320-c. For example, the DMS 110-d may perform intermediary KEK rotation as described herein. Intermediary KEK rotation may be periodic (e.g., time based periodicity) or may be triggered on demand. For example, intermediary KEK rotation may be scheduled every x days but a customer may trigger intermediary KEK rotation between the x days. In some examples, once a new intermediary KEK is created, prior KEKs may not be used (e.g., the new intermediary KEK may be used to encrypt DEKs going forward until another new KEK is created).

In some examples, the DMS 110-d may encrypt a third DEK using the first intermediary KEK. The DMS 110-d may encrypt third set of data blocks using the third DEK. The backup data may include the third set of data blocks. The DMS 110-d may store the encrypted third set of data blocks along with the encrypted third DEK in the one or more storage locations 320-c. In some examples, encrypting the third set of data blocks using the third DEK may be based on a quantity of data blocks of the first set of data blocks satisfying a threshold quantity of data blocks. In some examples, each data block may be encrypted by a unique DEK.

In some examples, encrypting the second DEK using the second intermediary KEK may be based on a duration associated with use of the first intermediary KEK satisfying a threshold duration.

In some examples, encrypting the second DEK using the second intermediary KEK may be based on a quantity of data blocks encrypted in association with the first intermediary KEK satisfying a threshold quantity of data blocks.

In some examples, encrypting the first set of data blocks using the first DEK may be based on the first set of data blocks being stored at a first storage location of the one or more storage locations 320-c (e.g., a first archive location), and encrypting the second set of data blocks using the second DEK may be based on the second set of data blocks being stored at a second storage location of the one or more storage locations 320-c (e.g., a second archive location).

In some examples, the DMS 110-d may obtain a request to retrieve the backup data from the one or more storage locations 320-c. The DMS 110-d may retrieve the encrypted first set of data blocks along with the encrypted first DEK and the encrypted second set of data blocks along with the encrypted second DEK from the one or more storage locations 320-c. The DMS 110-d may decrypt the first intermediary KEK and the second intermediary KEK using the root KEK. The DMS 110-d may decrypt the first DEK using the decrypted first intermediary KEK and the second DEK using the decrypted second intermediary KEK. The DMS 110-d may decrypt the encrypted first set of data blocks using the decrypted first DEK and the encrypted second set of data blocks using the decrypted second DEK to retrieve the backup data. The DMS 110-d may restore the retrieved backup data to the computing object 305-a or one or more additional computing objects. The DMS 110-d may obtain the request via receiving a request to perform a restore operation for the backup data to the computing object 305-a or the one or more additional computing objects.

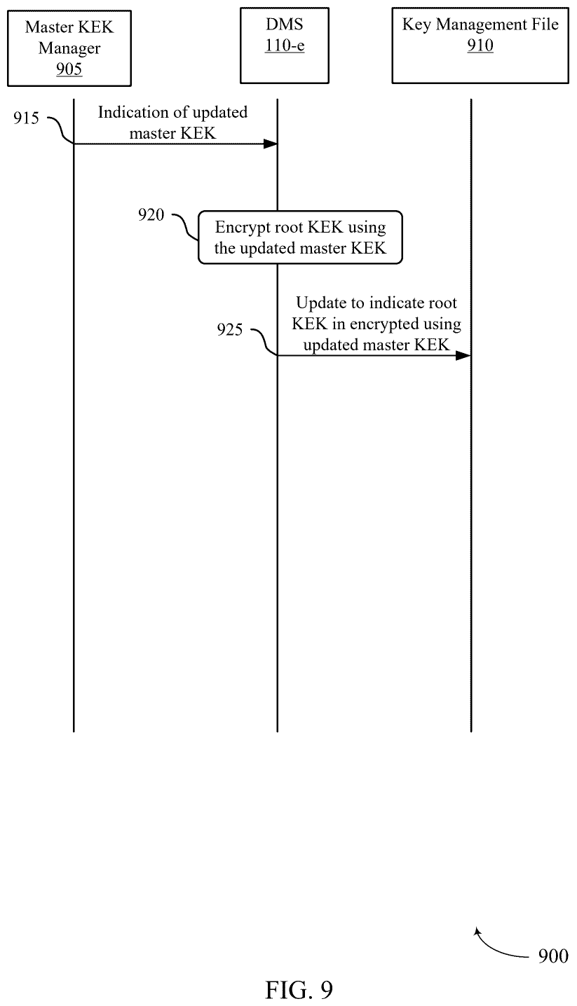

FIG. 9 shows an example of a process flow 900 that supports encryption key hierarchy for data encryption management in accordance with aspects of the present disclosure. The process flow 800 may implement or may be implemented by one or more aspects of the computing environment 100, the encryption key hierarchy, or the computing environment 300. For example, the process flow 900 may include a DMS 110-e, which may be an example of a DMS 110 as described herein. The process flow 900 may include a master KEK manager 905. In some examples, the master KEK manager 905 may be an example of a KMS 330 as described herein. In some examples, the master KEK manager 905 may be an example of a computing device 115 (e.g., in scenarios where a customer manually provides a master KEK such as providing a passphrase). The process flow 900 may include a key hierarchy management file, which may be an example of a key hierarchy file 350 as described herein. In the following description of the process flow 900, operations between the DMS 110-e, the master KEK manager 905, and the key management file 910 may be added, omitted, or performed in a different order (with respect to the exemplary order shown).

At 915, the DMS 110-e may obtain, from the master KEK manager 905, an indication of an updated master KEK for an encryption key hierarchy associated with backup data managed by the DMS 110-e. In association with the encryption key hierarchy, a current master KEK encrypts a root KEK, the root KEK encrypts one or more intermediary KEKs, the one or more intermediary KEKs encrypt one or more respective DEKs, and the one or more respective DEKs encrypt one or more respective data blocks of the backup data. The one or more respective data blocks may be stored at one or more storage locations (e.g., storage locations 320 as described herein) accessible to the DMS 110-e. The key management file 910 may be accessible to the DMS 110-e (e.g., may be stored locally at the DMS 110-e or may be stored at the one or more storage locations). The key management file 910 may indicate the encryption key hierarchy associated with the backup data. For example, the key management file 910 may be a metadata file that may include the DEKs encrypted by the intermediary KEKs, the intermediary KEKs encrypted by the root KEK, and the root KEK encrypted by the current master KEK. The key management file 910 may include metadata that indicates a source of the master KEK. For example, where the master KEK is provided via a KMS 330 as described herein, the key management file 910 may indicate a KMS instance, version, and identifier such that a user with access to the KMS 330 may obtain the master KEK to decrypt the key hierarchy in the key management file 910 (e.g., the root KEK, and subsequently the intermediary KEKs and DEKs).

In some examples, the DMS 110-e may receive the updated master KEK from an external KMS as described herein. In some examples, a user account associated with a customer (e.g., an administrative account or an owner account) may manually provide an updated master KEK, for example from a computing device 115 as described herein. In some examples, the master KEK may be periodically updated (e.g., the KMS 330 may provide weekly, bi-weekly, monthly, bi-monthly, etc.) updates for the master KEK.

At 920, the DMS 110-e may encrypt the root KEK using the updated master KEK.

At 925, the DMS 110-e may update the key management file 910 to indicate that the root KEK is encrypted using the updated master KEK (e.g., the key management file 910 may indicate the updated source of the master KEK, such as a new version or identifier of the updated master KEK).

In some examples, the DMS 110-e may store the one or more respective data blocks along with the one or more respective DEKs at the one or more storage locations, and at least one storage location of the one or more storage locations may have an activated immutability lock (e.g., the at least one storage location may be an immutable archive). In such examples, the DMS 110-e may encrypt the root KEK while the immutability lock for the at least one storage location is activated.

In some examples, the DMS 110-e may update a secondary key management file based on updating the key management file. For example, the key management file 910 may be accessible to a first customer account with read/write permissions for the backup data (e.g., an owner account for the storage location(s) at which the backup data is stored), and the secondary key management file may be accessible to a second customer account with read-only permissions for the backup data (e.g., a reader account for the storage location(s) at which the backup data is stored).

In some examples, the DMS 110-e may obtain a request to retrieve the backup data from the one or more storage locations. The DMS 110-e may retrieve the encrypted one or more respective data blocks of the backup data. The DMS 110-e may decrypt, based on the encryption key hierarchy indicated by the key management file 910, the one or more respective DEKs. The DMS 110-e may decrypt the encrypted one or more respective data blocks using the decrypted one or more respective DEKs to extract the one or more respective data blocks. In some examples, the DMS 110-e may restore the retrieved backup data to one or more computing objects, and obtaining the request may involve receiving a request to perform a restore operation for the backup data to the one or more computing objects. In some examples, obtaining the request to retrieve the backup data may involve receiving the request from a computing device associated with a customer account with read-only permissions for the backup data (e.g., from a reader account), and the decrypting is based on the request including an indication of the updated master KEK. For example, the reader account may provide the updated master KEK which matches the updated master KEK provided at 915, and the DMS 110-e is able to decrypt the key management file 910 based on provision by the reader account of the updated master KEK in the restore request.

In some examples, the DMS 110-e may generate, based on obtaining the indication of the updated master KEK, a backup key management file that indicates the encryption key hierarchy that includes the current master KEK prior to encrypting the root KEK using the updated master KEK. In some examples, the DMS 110-e may generate the key management file 910 based on encrypting data blocks using the one or more DEKs (e.g., the key management file 910 may be created based on encryption in accordance with the key hierarchy indicated in the key management file 910).

In some examples, a first DEK encrypts one or more first data blocks of the backup data, a second DEK encrypts one or more second data blocks of the backup data based on a quantity of data blocks of the one or more first data blocks satisfying a threshold, and wherein a first intermediary KEK of the one or more intermediary KEKs encrypts both the first DEK and the second DEK.

In some examples, a first DEK encrypts one or more first data blocks of the backup data based on the one or more first data blocks being stored at a first storage location of the one or more storage locations, a second DEK encrypts one or more second data blocks of the backup data based on the one or more second data blocks being stored at a second storage location of the one or more storage locations, and a first intermediary KEK of the one or more intermediary KEKs encrypts both the first DEK and the second DEK.

In some examples, a first intermediary KEK of the one or more intermediary KEKs encrypts one or more first DEKs, and a second intermediary KEK of the one or more intermediary KEKs encrypts one or more second DEKs based on a quantity of data blocks encrypted by the one or more first DEKs satisfying a threshold. For example, intermediary KEK rotation may be performed based on an amount of data encrypted using each intermediary KEK.

In some examples, a first intermediary KEK of the one or more intermediary KEKs encrypts one or more first DEKs, and a second intermediary KEK of the one or more intermediary KEKs encrypts one or more second DEKs based on a duration associated with use of the first intermediary KEK satisfying a threshold duration. For example, intermediary KEK rotation may be performed based on periodic durations.

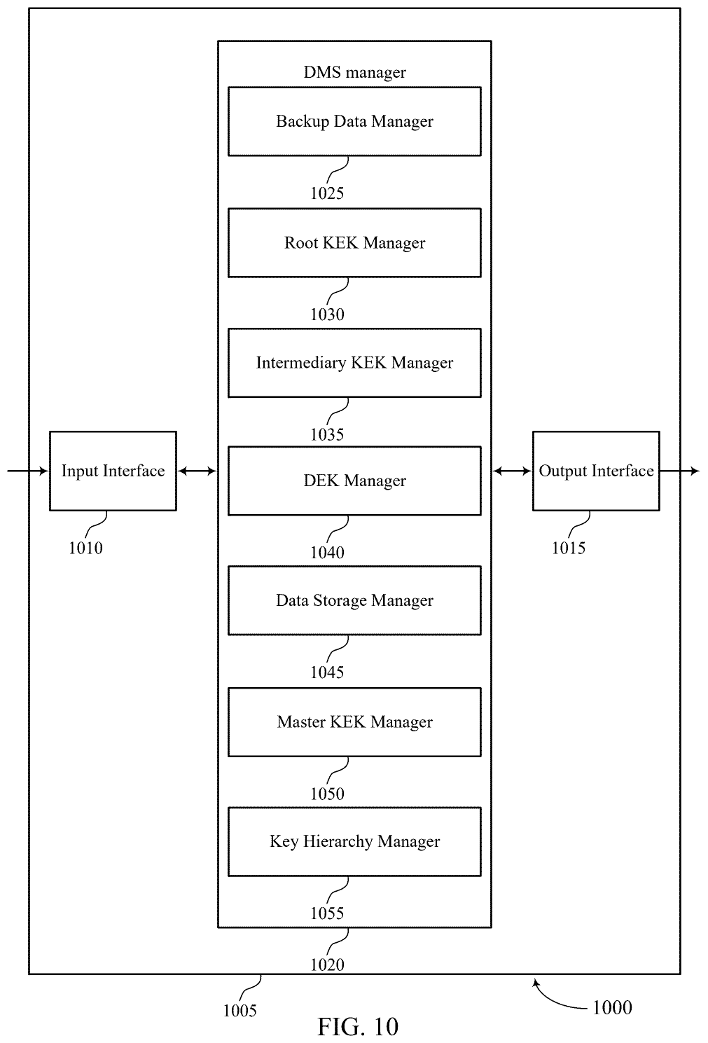

FIG. 10 shows a block diagram 1000 of a system 1005 that supports encryption key hierarchy for data encryption management in accordance with aspects of the present disclosure. In some examples, the system 1005 may be an example of aspects of one or more components described with reference to FIG. 1, such as a DMS 110. The system 1005 may include an input interface 1010, an output interface 1015, and a DMS manager 1020. The system 1005 may also include one or more processors. Each of these components may be in communication with one another (e.g., via one or more buses, communications links, communications interfaces, or any combination thereof).

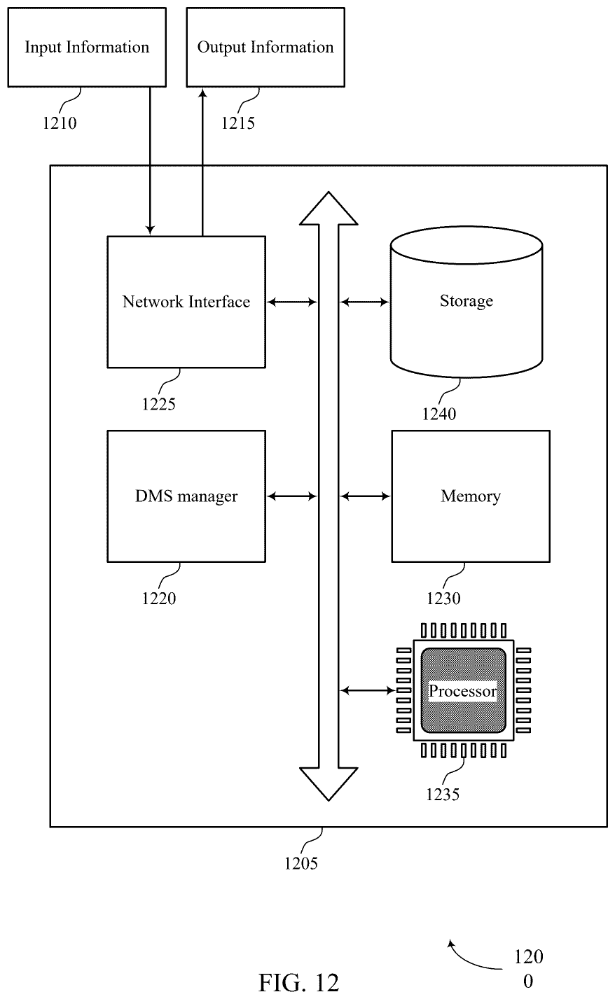

The input interface 1010 may manage input signaling for the system 1005. For example, the input interface 1010 may receive input signaling (e.g., messages, packets, data, instructions, commands, or any other form of encoded information) from other systems or devices. The input interface 1010 may send signaling corresponding to (e.g., representative of or otherwise based on) such input signaling to other components of the system 1005 for processing. For example, the input interface 1010 may transmit such corresponding signaling to the DMS manager 1020 to support encryption key hierarchy for data encryption management. In some cases, the input interface 1010 may be a component of a network interface 1225 as described with reference to FIG. 12.

The output interface 1015 may manage output signaling for the system 1005. For example, the output interface 1015 may receive signaling from other components of the system 1005, such as the DMS manager 1020, and may transmit such output signaling corresponding to (e.g., representative of or otherwise based on) such signaling to other systems or devices. In some cases, the output interface 1015 may be a component of a network interface 1225 as described with reference to FIG. 12.

For example, the DMS manager 1020 may include a backup data manager 1025, a root KEK manager 1030, an intermediary KEK manager 1035, a DEK manager 1040, a data storage manager 1045, a master KEK manager 1050, a key hierarchy manager 1055, or any combination thereof. In some examples, the DMS manager 1020, or various components thereof, may be configured to perform various operations (e.g., receiving, monitoring, transmitting) using or otherwise in cooperation with the input interface 1010, the output interface 1015, or both. For example, the DMS manager 1020 may receive information from the input interface 1010, send information to the output interface 1015, or be integrated in combination with the input interface 1010, the output interface 1015, or both to receive information, transmit information, or perform various other operations as described herein.

The backup data manager 1025 may be configured as or otherwise support a means for obtaining, by a DMS, backup data associated with one or more computing objects. The root KEK manager 1030 may be configured as or otherwise support a means for encrypting, by the DMS, a first intermediary KEK and a second intermediary KEK using a root KEK. The intermediary KEK manager 1035 may be configured as or otherwise support a means for encrypting, by the DMS, a first DEK using the first intermediary KEK and a second DEK using the second intermediary KEK. The DEK manager 1040 may be configured as or otherwise support a means for encrypting, by the DMS, a first set of data blocks using the first DEK and a second set of data blocks using the second DEK, the backup data including the first set of data blocks and the second set of data blocks. The data storage manager 1045 may be configured as or otherwise support a means for storing, by the DMS, the encrypted first set of data blocks along with the encrypted first DEK and the encrypted second set of data blocks along with the encrypted second DEK in one or more storage locations accessible to the DMS.

The master KEK manager 1050 may be configured as or otherwise support a means for obtaining, by a DMS, an indication of an updated master KEK for an encryption key hierarchy associated with backup data managed by the DMS, where, in association with the encryption key hierarchy, a current master KEK encrypts a root KEK, the root KEK encrypts one or more intermediary KEKs, the one or more intermediary KEKs encrypt one or more respective DEKs, and the one or more respective DEKs encrypt one or more respective data blocks of the backup data, where the one or more respective data blocks are stored at one or more storage locations accessible to the DMS, and where a key management file accessible to the DMS indicates the encryption key hierarchy associated with the backup data. The master KEK manager 1050 may be configured as or otherwise support a means for encrypting, by the DMS, the root KEK using the updated master KEK. The key hierarchy manager 1055 may be configured as or otherwise support a means for updating the key management file to indicate that the root KEK is encrypted using the updated master KEK.

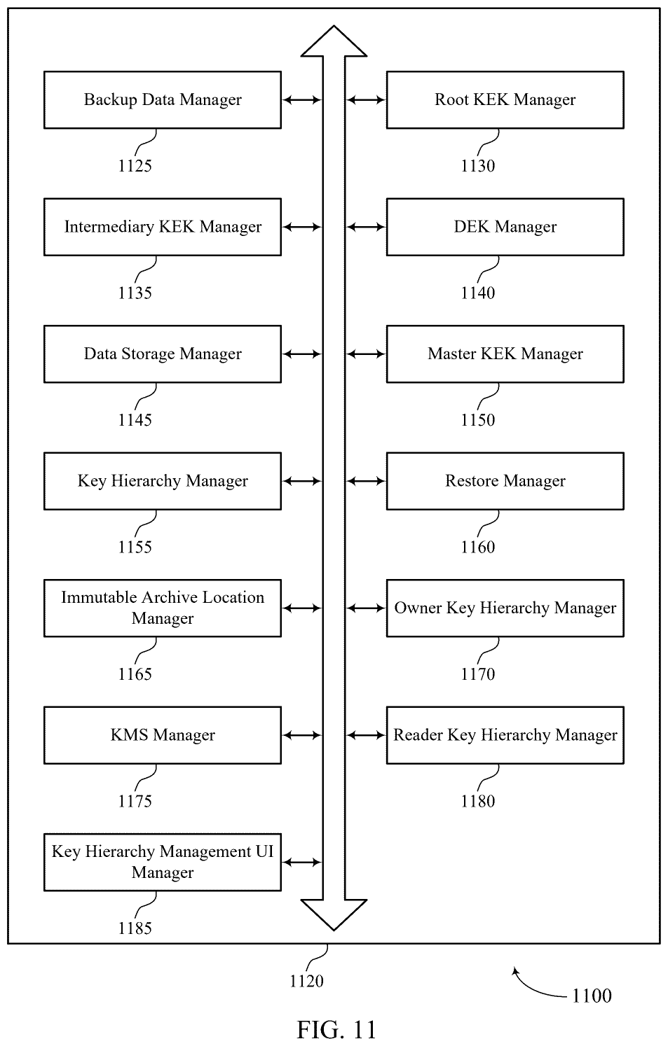

FIG. 11 shows a block diagram 1100 of a DMS manager 1120 that supports encryption key hierarchy for data encryption management in accordance with aspects of the present disclosure. The DMS manager 1120 may be an example of aspects of a DMS manager or a DMS manager 1020, or both, as described herein. The DMS manager 1120, or various components thereof, may be an example of means for performing various aspects of encryption key hierarchy for data encryption management as described herein. For example, the DMS manager 1120 may include a backup data manager 1125, a root KEK manager 1130, an intermediary KEK manager 1135, a DEK manager 1140, a data storage manager 1145, a master KEK manager 1150, a key hierarchy manager 1155, a restore manager 1160, an immutable archive location manager 1165, an owner key hierarchy manager 1170, an KMS manager 1175, a reader key hierarchy manager 1180, a key hierarchy management UI manager 1185, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The backup data manager 1125 may be configured as or otherwise support a means for obtaining, by a DMS, backup data associated with one or more computing objects. The root KEK manager 1130 may be configured as or otherwise support a means for encrypting, by the DMS, a first intermediary KEK and a second intermediary KEK using a root KEK. The intermediary KEK manager 1135 may be configured as or otherwise support a means for encrypting, by the DMS, a first DEK using the first intermediary KEK and a second DEK using the second intermediary KEK. The DEK manager 1140 may be configured as or otherwise support a means for encrypting, by the DMS, a first set of data blocks using the first DEK and a second set of data blocks using the second DEK, the backup data including the first set of data blocks and the second set of data blocks. The data storage manager 1145 may be configured as or otherwise support a means for storing, by the DMS, the encrypted first set of data blocks along with the encrypted first DEK and the encrypted second set of data blocks along with the encrypted second DEK in one or more storage locations accessible to the DMS.

In some examples, the master KEK manager 1150 may be configured as or otherwise support a means for encrypting, by the DMS, the root KEK using (e.g., with) a master KEK.

In some examples, the master KEK manager 1150 may be configured as or otherwise support a means for encrypting, by the DMS, the root KEK using (e.g., with) an updated master KEK based on a duration since encrypting the root KEK using (e.g., with) the master KEK satisfying a threshold duration.

In some examples, the key hierarchy manager 1155 may be configured as or otherwise support a means for storing, by the DMS in a key management file accessible to the DMS, an indication of a key hierarchy associated with the backup data, the key hierarchy including the master KEK, the root KEK, the first intermediary KEK, the second DEK, the first DEK, and the second DEK.

In some examples, the key hierarchy management UI manager 1185 may be configured as or otherwise support a means for causing display, by the DMS on a user interface associated with an administrator account of the DMS, of an indication of the key hierarchy based on the key management file.

In some examples, the display indicates associations between data KEKs and intermediary KEKs and respective storage locations of the one or more storage locations.

In some examples, the master KEK manager 1150 may be configured as or otherwise support a means for receiving, by the DMS, the master KEK from a computing device associated with a customer account associated with the one or more computing objects.

In some examples, the master KEK manager 1150 may be configured as or otherwise support a means for receiving, by the DMS from the computing device after encrypting the root KEK, an updated master KEK. In some examples, the master KEK manager 1150 may be configured as or otherwise support a means for encrypting, by the DMS, the root KEK with the updated master KEK.

In some examples, the backup data manager 1125 may be configured as or otherwise support a means for obtaining, by the DMS after obtaining the backup data, additional backup data associated with the one or more computing objects. In some examples, the root KEK manager 1130 may be configured as or otherwise support a means for encrypting, by the DMS, a third intermediary KEK using the root KEK. In some examples, the intermediary KEK manager 1135 may be configured as or otherwise support a means for encrypting, by the DMS, a third DEK using the third intermediary KEK. In some examples, the DEK manager 1140 may be configured as or otherwise support a means for encrypting, by the DMS, a third set of data blocks of the additional backup data using the third DEK. In some examples, the data storage manager 1145 may be configured as or otherwise support a means for storing, by the DMS, the encrypted third set of data blocks along with the encrypted third DEK in the one or more storage locations.

In some examples, the intermediary KEK manager 1135 may be configured as or otherwise support a means for encrypting, by the DMS, a third DEK using the first intermediary KEK. In some examples, the DEK manager 1140 may be configured as or otherwise support a means for encrypting, by the DMS, a third set of data blocks using the third DEK, the backup data including the third set of data blocks. In some examples, the data storage manager 1145 may be configured as or otherwise support a means for storing, by the DMS, the encrypted third set of data blocks along with the encrypted third DEK in the one or more storage locations.

In some examples, encrypting the third set of data blocks using the third DEK is based on a quantity of data blocks of the first set of data blocks satisfying a threshold quantity of data blocks.

In some examples, encrypting the second DEK using the second intermediary KEK is based on a quantity of data blocks encrypted in association with the first intermediary KEK satisfying a threshold quantity of data blocks.

In some examples, encrypting the second DEK using the second intermediary KEK is based on a duration associated with use of the first intermediary KEK satisfying a threshold duration.

In some examples, encrypting the first set of data blocks using the first DEK is based on the first set of data blocks being stored at a first storage location of the one or more storage locations. In some examples, encrypting the second set of data blocks using the second DEK is based on the second set of data blocks being stored at a second storage location of the one or more storage locations.

In some examples, the restore manager 1160 may be configured as or otherwise support a means for obtaining, by the DMS, a request to retrieve the backup data from the one or more storage locations. In some examples, the restore manager 1160 may be configured as or otherwise support a means for retrieving, by the DMS, the encrypted first set of data blocks along with the encrypted first DEK and the encrypted second set of data blocks along with the encrypted second DEK from the one or more storage locations. In some examples, the root KEK manager 1130 may be configured as or otherwise support a means for decrypting, by the DMS, the first intermediary KEK and the second intermediary KEK using the root KEK. In some examples, the intermediary KEK manager 1135 may be configured as or otherwise support a means for decrypting, by the DMS, the first DEK using the decrypted first intermediary KEK and the second DEK using the decrypted second intermediary KEK. In some examples, the DEK manager 1140 may be configured as or otherwise support a means for decrypting, by the DMS, the encrypted first set of data blocks using the decrypted first DEK and the encrypted second set of data blocks using the decrypted second DEK to retrieve the backup data.

In some examples, the restore manager 1160 may be configured as or otherwise support a means for restoring the retrieved backup data to the one or more computing objects or one or more additional computing objects, where obtaining the request includes receiving a request to perform a restore operation for the backup data to the one or more computing objects or the one or more additional computing objects.

The master KEK manager 1150 may be configured as or otherwise support a means for obtaining, by a DMS, an indication of an updated master KEK for an encryption key hierarchy associated with backup data managed by the DMS, where, in association with the encryption key hierarchy, a current master KEK encrypts a root KEK, the root KEK encrypts one or more intermediary KEKs, the one or more intermediary KEKs encrypt one or more respective DEKs, and the one or more respective DEKs encrypt one or more respective data blocks of the backup data, where the one or more respective data blocks are stored at one or more storage locations accessible to the DMS, and where a key management file accessible to the DMS indicates the encryption key hierarchy associated with the backup data. In some examples, the master KEK manager 1150 may be configured as or otherwise support a means for encrypting, by the DMS, the root KEK using the updated master KEK. The key hierarchy manager 1155 may be configured as or otherwise support a means for updating the key management file to indicate that the root KEK is encrypted using the updated master KEK.

In some examples, the data storage manager 1145 may be configured as or otherwise support a means for storing, by the DMS, the one or more respective data blocks along with the one or more respective DEKs at the one or more storage locations. In some examples, the immutable archive location manager 1165 may be configured as or otherwise support a means for activating, by the DMS, an immutability lock for at least one storage location of the one or more storage locations.

In some examples, to support encrypting the root KEK, the master KEK manager 1150 may be configured as or otherwise support a means for encrypting the root KEK while the immutability lock for the at least one storage location is activated.

In some examples, the owner key hierarchy manager 1170 may be configured as or otherwise support a means for updating, by the DMS, a secondary key management file based on updating the key management file, where the key management file is accessible to a first customer account with read/write permissions for the backup data, and where the secondary key management file is accessible to a second customer account with read-only permissions for the backup data.

In some examples, to support obtaining the indication of the updated master KEK, the master KEK manager 1150 may be configured as or otherwise support a means for receiving, by the DMS, the updated master KEK from a computing device that is associated with a customer account associated with the backup data.

In some examples, to support obtaining the indication of the updated master KEK, the KMS manager 1175 may be configured as or otherwise support a means for obtaining the updated master KEK from a key management service.

In some examples, obtaining the indication of the updated master KEK is based on a duration since reception of the current master KEK satisfying a threshold duration.

In some examples, the restore manager 1160 may be configured as or otherwise support a means for obtaining, by the DMS, a request to retrieve the backup data from the one or more storage locations. In some examples, the restore manager 1160 may be configured as or otherwise support a means for retrieving, by the DMS, the encrypted one or more respective data blocks of the backup data. In some examples, the intermediary KEK manager 1135 may be configured as or otherwise support a means for decrypting, by the DMS, based on the encryption key hierarchy indicated by the key management file, the one or more respective DEKs. In some examples, the DEK manager 1140 may be configured as or otherwise support a means for decrypting, by the DMS, the encrypted one or more respective data blocks using the decrypted one or more respective DEKs to extract the one or more respective data blocks.

In some examples, the restore manager 1160 may be configured as or otherwise support a means for restoring the retrieved backup data to one or more computing objects, where obtaining the request includes receiving a request to perform a restore operation for the backup data to the one or more computing objects.

In some examples, to support obtaining the request to retrieve the backup data, the reader key hierarchy manager 1180 may be configured as or otherwise support a means for receiving the request from a computing device associated with a customer account with read-only permissions for the backup data, where the decrypting is based on the request including an indication of the updated master KEK.

In some examples, the key hierarchy manager 1155 may be configured as or otherwise support a means for generating, by the DMS and based on obtaining the indication of the updated master KEK, a backup key management file that indicates the encryption key hierarchy including the current master KEK prior to encrypting the root KEK using the updated master KEK.

In some examples, the key hierarchy manager 1155 may be configured as or otherwise support a means for generating, based on encrypting the one or more respective data blocks using the one or more respective DEKs, the key management file.

In some examples, a first DEK encrypts one or more first data blocks of the backup data. In some examples, a second DEK encrypts one or more second data blocks of the backup data based on a quantity of data blocks of the one or more first data blocks satisfying a threshold. In some examples, a first intermediary KEK of the one or more intermediary KEKs encrypts both the first DEK and the second DEK.

In some examples, a first DEK encrypts one or more first data blocks of the backup data based on the one or more first data blocks being stored at a first storage location of the one or more storage locations, a second DEK encrypts one or more second data blocks of the backup data based on the one or more second data blocks being stored at a second storage location of the one or more storage locations. In some examples, a first intermediary KEK of the one or more intermediary KEKs encrypts both the first DEK and the second DEK.

In some examples, a first intermediary KEK of the one or more intermediary KEKs encrypts one or more first DEKs. In some examples, a second intermediary KEK of the one or more intermediary KEKs encrypts one or more second DEKs based on a quantity of data blocks encrypted by the one or more first DEKs satisfying a threshold.

In some examples, a first intermediary KEK of the one or more intermediary KEKs encrypts one or more first DEKs. In some examples, a second intermediary KEK of the one or more intermediary KEKs encrypts one or more second DEKs based on a duration associated with use of the first intermediary KEK satisfying a threshold duration.

FIG. 12 shows a block diagram 1200 of a system 1205 that supports encryption key hierarchy for data encryption management in accordance with aspects of the present disclosure. The system 1205 may be an example of or include components of a system 1005 as described herein. The system 1205 may include components for data management, including components such as a DMS manager 1220, an input information 1210, an output information 1215, a network interface 1225, at least one memory 1230, at least one processor 1235, and a storage 1240. These components may be in electronic communication or otherwise coupled with each other (e.g., operatively, communicatively, functionally, electronically, electrically; via one or more buses, communications links, communications interfaces, or any combination thereof). Additionally, the components of the system 1205 may include corresponding physical components or may be implemented as corresponding virtual components (e.g., components of one or more virtual machines). In some examples, the system 1205 may be an example of aspects of one or more components described with reference to FIG. 1, such as a DMS 110.

The network interface 1225 may enable the system 1205 to exchange information (e.g., input information 1210, output information 1215, or both) with other systems or devices (not shown). For example, the network interface 1225 may enable the system 1205 to connect to a network (e.g., a network 120 as described herein). The network interface 1225 may include one or more wireless network interfaces, one or more wired network interfaces, or any combination thereof. In some examples, the network interface 1225 may be an example of may be an example of aspects of one or more components described with reference to FIG. 1, such as one or more network interfaces 165.

Memory 1230 may include RAM, ROM, or both. The memory 1230 may store computer-readable, computer-executable software including instructions that, when executed, cause the processor 1235 to perform various functions described herein. In some cases, the memory 1230 may contain, among other things, a basic input/output system (BIOS), which may control basic hardware or software operation such as the interaction with peripheral components or devices. In some cases, the memory 1230 may be an example of aspects of one or more components described with reference to FIG. 1, such as one or more memories 175.

The processor 1235 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 1235 may be configured to execute computer-readable instructions stored in a memory 1230 to perform various functions (e.g., functions or tasks supporting encryption key hierarchy for data encryption management). Though a single processor 1235 is depicted in the example of FIG. 12, it is to be understood that the system 1205 may include any quantity of one or more of processors 1235 and that a group of processors 1235 may collectively perform one or more functions ascribed herein to a processor, such as the processor 1235. In some cases, the processor 1235 may be an example of aspects of one or more components described with reference to FIG. 1, such as one or more processors 170.

Storage 1240 may be configured to store data that is generated, processed, stored, or otherwise used by the system 1205. In some cases, the storage 1240 may include one or more HDDs, one or more SDDs, or both. In some examples, the storage 1240 may be an example of a single database, a distributed database, multiple distributed databases, a data store, a data lake, or an emergency backup database. In some examples, the storage 1240 may be an example of one or more components described with reference to FIG. 1, such as one or more network disks 180.

For example, the DMS manager 1220 may be configured as or otherwise support a means for obtaining, by a DMS, backup data associated with one or more computing objects. The DMS manager 1220 may be configured as or otherwise support a means for encrypting, by the DMS, a first intermediary KEK and a second intermediary KEK using a root KEK. The DMS manager 1220 may be configured as or otherwise support a means for encrypting, by the DMS, a first DEK using the first intermediary KEK and a second DEK using the second intermediary KEK. The DMS manager 1220 may be configured as or otherwise support a means for encrypting, by the DMS, a first set of data blocks using the first DEK and a second set of data blocks using the second DEK, the backup data including the first set of data blocks and the second set of data blocks. The DMS manager 1220 may be configured as or otherwise support a means for storing, by the DMS, the encrypted first set of data blocks along with the encrypted first DEK and the encrypted second set of data blocks along with the encrypted second DEK in one or more storage locations accessible to the DMS.

Additionally or alternatively, the DMS manager 1220 may be configured as or otherwise support a means for obtaining, by a DMS, an indication of an updated master KEK for an encryption key hierarchy associated with backup data managed by the DMS, where, in association with the encryption key hierarchy, a current master KEK encrypts a root KEK, the root KEK encrypts one or more intermediary KEKs, the one or more intermediary KEKs encrypt one or more respective DEKs, and the one or more respective DEKs encrypt one or more respective data blocks of the backup data, where the one or more respective data blocks are stored at one or more storage locations accessible to the DMS, and where a key management file accessible to the DMS indicates the encryption key hierarchy associated with the backup data. The DMS manager 1220 may be configured as or otherwise support a means for encrypting, by the DMS, the root KEK using the updated master KEK. The DMS manager 1220 may be configured as or otherwise support a means for updating the key management file to indicate that the root KEK is encrypted using the updated master KEK.

By including or configuring the DMS manager 1220 in accordance with examples as described herein, the system 1205 may support techniques for encryption key hierarchy for data encryption management, which may provide one or more benefits such as, for example, more secure encryption, reduced spread in the event of data breaches, more efficient utilization of computing resources, network resources or both, improved scalability, and improved security, among other possibilities.

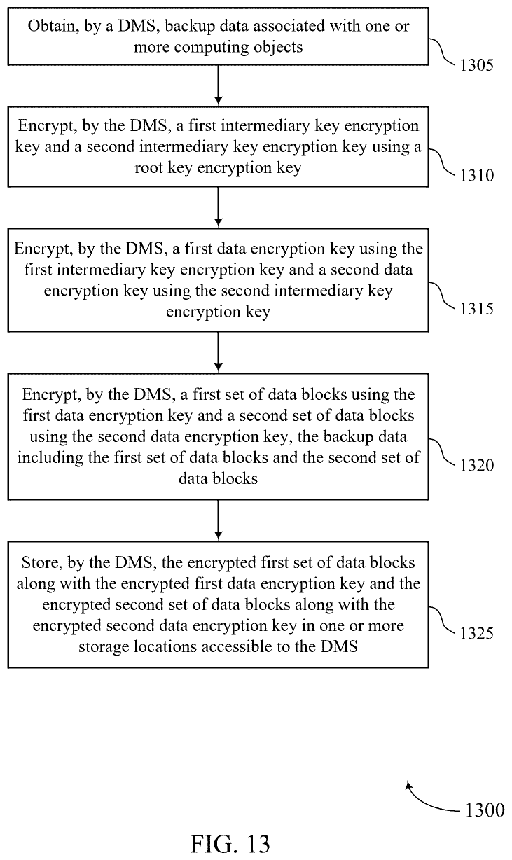

FIG. 13 shows a flowchart illustrating a method 1300 that supports encryption key hierarchy for data encryption management in accordance with aspects of the present disclosure. The operations of the method 1300 may be implemented by a DMS or its components as described herein. For example, the operations of the method 1300 may be performed by a DMS as described with reference to FIGS. 1 through 12. In some examples, a DMS may execute a set of instructions to control the functional elements of the DMS to perform the described functions. Additionally, or alternatively, the DMS may perform aspects of the described functions using special-purpose hardware.

At 1305, the method may include obtaining, by a DMS, backup data associated with one or more computing objects. The operations of 1305 may be performed in accordance with examples as disclosed herein. In some examples, aspects of the operations of 1305 may be performed by a backup data manager 1125 as described with reference to FIG. 11.

At 1310, the method may include encrypting, by the DMS, a first intermediary KEK and a second intermediary KEK using a root KEK. The operations of 1310 may be performed in accordance with examples as disclosed herein. In some examples, aspects of the operations of 1310 may be performed by a root KEK manager 1130 as described with reference to FIG. 11.

At 1315, the method may include encrypting, by the DMS, a first DEK using the first intermediary KEK and a second DEK using the second intermediary KEK. The operations of 1315 may be performed in accordance with examples as disclosed herein. In some examples, aspects of the operations of 1315 may be performed by an intermediary KEK manager 1135 as described with reference to FIG. 11.

At 1320, the method may include encrypting, by the DMS, a first set of data blocks using the first DEK and a second set of data blocks using the second DEK, the backup data including the first set of data blocks and the second set of data blocks. The operations of 1320 may be performed in accordance with examples as disclosed herein. In some examples, aspects of the operations of 1320 may be performed by a DEK manager 1140 as described with reference to FIG. 11.

At 1325, the method may include storing, by the DMS, the encrypted first set of data blocks along with the encrypted first DEK and the encrypted second set of data blocks along with the encrypted second DEK in one or more storage locations accessible to the DMS. The operations of 1325 may be performed in accordance with examples as disclosed herein. In some examples, aspects of the operations of 1325 may be performed by a data storage manager 1145 as described with reference to FIG. 11.

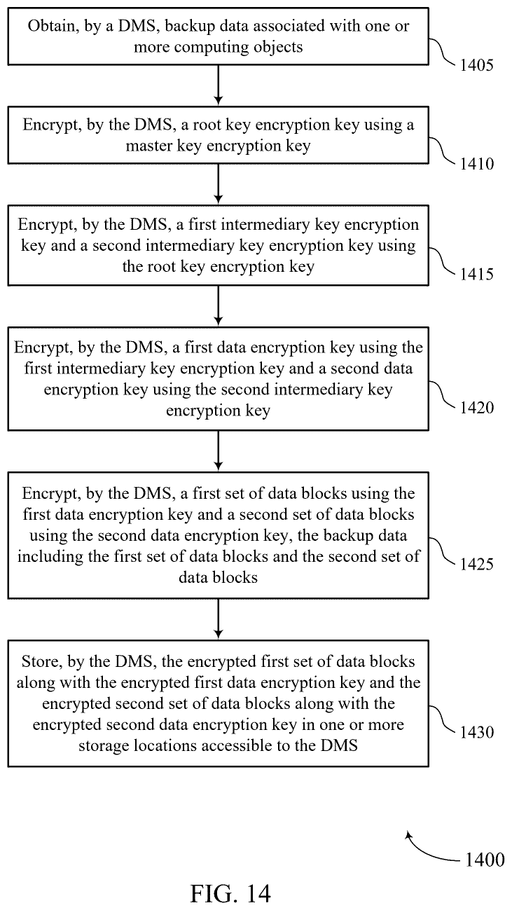

FIG. 14 shows a flowchart illustrating a method 1400 that supports encryption key hierarchy for data encryption management in accordance with aspects of the present disclosure. The operations of the method 1400 may be implemented by a DMS or its components as described herein. For example, the operations of the method 1400 may be performed by a DMS as described with reference to FIGS. 1 through 12. In some examples, a DMS may execute a set of instructions to control the functional elements of the DMS to perform the described functions. Additionally, or alternatively, the DMS may perform aspects of the described functions using special-purpose hardware.

At 1405, the method may include obtaining, by a DMS, backup data associated with one or more computing objects. The operations of 1405 may be performed in accordance with examples as disclosed herein. In some examples, aspects of the operations of 1405 may be performed by a backup data manager 1125 as described with reference to FIG. 11.

At 1410, the method may include encrypting, by the DMS, a root KEK using (e.g., with) a master KEK. The operations of 1410 may be performed in accordance with examples as disclosed herein. In some examples, aspects of the operations of 1410 may be performed by a master KEK manager 1150 as described with reference to FIG. 11.

At 1415, the method may include encrypting, by the DMS, a first intermediary KEK and a second intermediary KEK using the root KEK. The operations of 1415 may be performed in accordance with examples as disclosed herein. In some examples, aspects of the operations of 1415 may be performed by a root KEK manager 1130 as described with reference to FIG. 11.

At 1420, the method may include encrypting, by the DMS, a first DEK using the first intermediary KEK and a second DEK using the second intermediary KEK. The operations of 1420 may be performed in accordance with examples as disclosed herein. In some examples, aspects of the operations of 1420 may be performed by an intermediary KEK manager 1135 as described with reference to FIG. 11.

At 1425, the method may include encrypting, by the DMS, a first set of data blocks using the first DEK and a second set of data blocks using the second DEK, the backup data including the first set of data blocks and the second set of data blocks. The operations of 1425 may be performed in accordance with examples as disclosed herein. In some examples, aspects of the operations of 1425 may be performed by a DEK manager 1140 as described with reference to FIG. 11.

At 1430, the method may include storing, by the DMS, the encrypted first set of data blocks along with the encrypted first DEK and the encrypted second set of data blocks along with the encrypted second DEK in one or more storage locations accessible to the DMS. The operations of 1430 may be performed in accordance with examples as disclosed herein. In some examples, aspects of the operations of 1430 may be performed by a data storage manager 1145 as described with reference to FIG. 11.

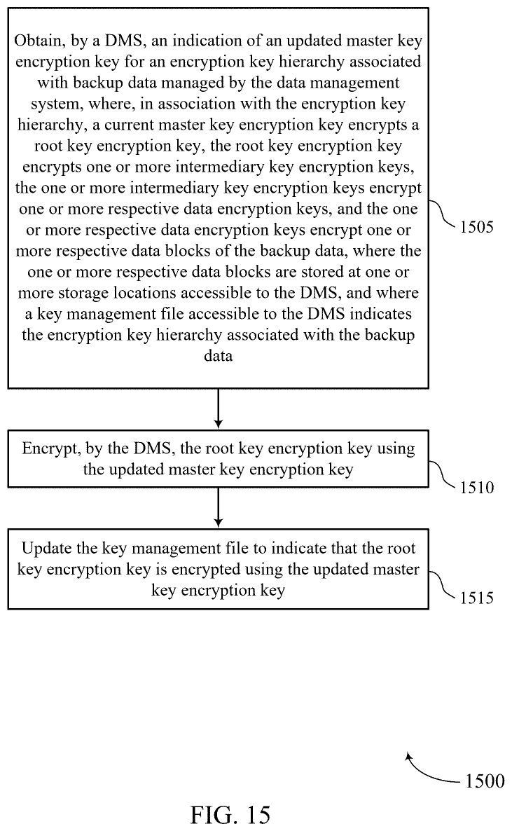

FIG. 15 shows a flowchart illustrating a method 1500 that supports encryption key hierarchy for data encryption management in accordance with aspects of the present disclosure. The operations of the method 1500 may be implemented by a DMS or its components as described herein. For example, the operations of the method 1500 may be performed by a DMS as described with reference to FIGS. 1 through 12. In some examples, a DMS may execute a set of instructions to control the functional elements of the DMS to perform the described functions. Additionally, or alternatively, the DMS may perform aspects of the described functions using special-purpose hardware.

At 1505, the method may include obtaining, by a DMS, an indication of an updated master KEK for an encryption key hierarchy associated with backup data managed by the DMS, where, in association with the encryption key hierarchy, a current master KEK encrypts a root KEK, the root KEK encrypts one or more intermediary KEKs, the one or more intermediary KEKs encrypt one or more respective DEKs, and the one or more respective DEKs encrypt one or more respective data blocks of the backup data, where the one or more respective data blocks are stored at one or more storage locations accessible to the DMS, and where a key management file accessible to the DMS indicates the encryption key hierarchy associated with the backup data. The operations of 1505 may be performed in accordance with examples as disclosed herein. In some examples, aspects of the operations of 1505 may be performed by a master KEK manager 1150 as described with reference to FIG. 11.

At 1510, the method may include encrypting, by the DMS, the root KEK using the updated master KEK. The operations of 1510 may be performed in accordance with examples as disclosed herein. In some examples, aspects of the operations of 1510 may be performed by a master KEK manager 1150 as described with reference to FIG. 11.

At 1515, the method may include updating the key management file to indicate that the root KEK is encrypted using the updated master KEK. The operations of 1515 may be performed in accordance with examples as disclosed herein. In some examples, aspects of the operations of 1515 may be performed by a key hierarchy manager 1155 as described with reference to FIG. 11.

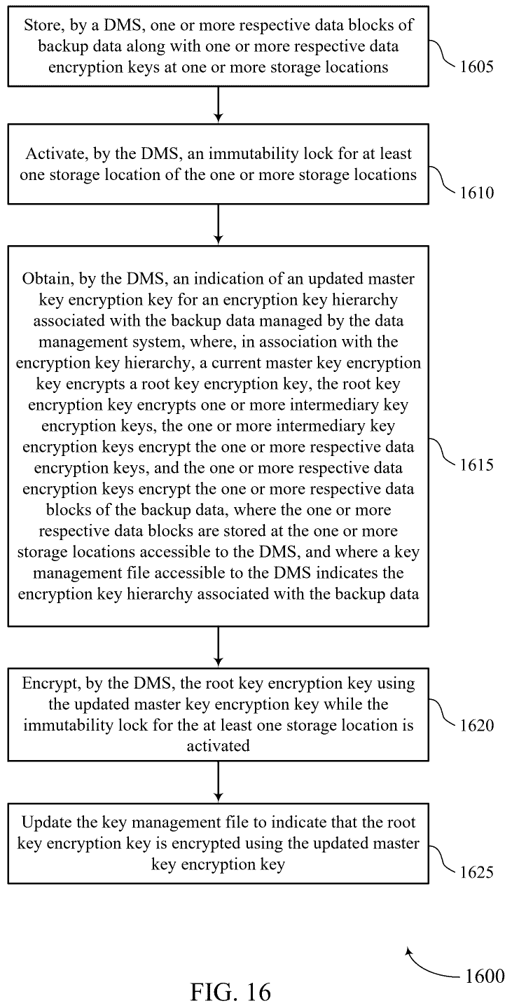

FIG. 16 shows a flowchart illustrating a method 1600 that supports encryption key hierarchy for data encryption management in accordance with aspects of the present disclosure. The operations of the method 1600 may be implemented by a DMS or its components as described herein. For example, the operations of the method 1600 may be performed by a DMS as described with reference to FIGS. 1 through 12. In some examples, a DMS may execute a set of instructions to control the functional elements of the DMS to perform the described functions. Additionally, or alternatively, the DMS may perform aspects of the described functions using special-purpose hardware.

At 1605, the method may include storing, by a DMS, one or more respective data blocks of backup data along with one or more respective DEKs at one or more storage locations. The operations of 1605 may be performed in accordance with examples as disclosed herein. In some examples, aspects of the operations of 1605 may be performed by a data storage manager 1145 as described with reference to FIG. 11.

At 1610, the method may include activating, by the DMS, an immutability lock for at least one storage location of the one or more storage locations. The operations of 1610 may be performed in accordance with examples as disclosed herein. In some examples, aspects of the operations of 1610 may be performed by an immutable archive location manager 1165 as described with reference to FIG. 11.

At 1615, the method may include obtaining, by the DMS, an indication of an updated master KEK for an encryption key hierarchy associated with the backup data managed by the DMS, where, in association with the encryption key hierarchy, a current master KEK encrypts a root KEK, the root KEK encrypts one or more intermediary KEKs, the one or more intermediary KEKs encrypt the one or more respective DEKs, and the one or more respective DEKs encrypt the one or more respective data blocks of the backup data, where the one or more respective data blocks are stored at the one or more storage locations accessible to the DMS, and where a key management file accessible to the DMS indicates the encryption key hierarchy associated with the backup data. The operations of 1615 may be performed in accordance with examples as disclosed herein. In some examples, aspects of the operations of 1615 may be performed by a master KEK manager 1150 as described with reference to FIG. 11.

At 1620, the method may include encrypting, by the DMS, the root KEK using the updated master KEK while the immutability lock for the at least one storage location is activated. The operations of 1620 may be performed in accordance with examples as disclosed herein. In some examples, aspects of the operations of 1620 may be performed by a master KEK manager 1150 as described with reference to FIG. 11.

At 1625, the method may include updating the key management file to indicate that the root KEK is encrypted using the updated master KEK. The operations of 1625 may be performed in accordance with examples as disclosed herein. In some examples, aspects of the operations of 1625 may be performed by a key hierarchy manager 1155 as described with reference to FIG. 11.

A method by an apparatus is described. The method may include obtaining, by a DMS, backup data associated with one or more computing objects, encrypting, by the DMS, a first intermediary KEK and a second intermediary KEK using a root KEK, encrypting, by the DMS, a first DEK using the first intermediary KEK and a second DEK using the second intermediary KEK, encrypting, by the DMS, a first set of data blocks using the first DEK and a second set of data blocks using the second DEK, the backup data including the first set of data blocks and the second set of data blocks, and storing, by the DMS, the encrypted first set of data blocks along with the encrypted first DEK and the encrypted second set of data blocks along with the encrypted second DEK in one or more storage locations accessible to the DMS.

An apparatus is described. The apparatus may include one or more memories storing processor executable code, and one or more processors coupled with the one or more memories. The one or more processors may individually or collectively be operable to execute the code to cause the apparatus to obtain, by a DMS, backup data associated with one or more computing objects, encrypt, by the DMS, a first intermediary KEK and a second intermediary KEK using a root KEK, encrypt, by the DMS, a first DEK using the first intermediary KEK and a second DEK using the second intermediary KEK, encrypt, by the DMS, a first set of data blocks using the first DEK and a second set of data blocks using the second DEK, the backup data including the first set of data blocks and the second set of data blocks, and store, by the DMS, the encrypted first set of data blocks along with the encrypted first DEK and the encrypted second set of data blocks along with the encrypted second DEK in one or more storage locations accessible to the DMS.

Another apparatus is described. The apparatus may include means for obtaining, by a DMS, backup data associated with one or more computing objects, means for encrypting, by the DMS, a first intermediary KEK and a second intermediary KEK using a root KEK, means for encrypting, by the DMS, a first DEK using the first intermediary KEK and a second DEK using the second intermediary KEK, means for encrypting, by the DMS, a first set of data blocks using the first DEK and a second set of data blocks using the second DEK, the backup data including the first set of data blocks and the second set of data blocks, and means for storing, by the DMS, the encrypted first set of data blocks along with the encrypted first DEK and the encrypted second set of data blocks along with the encrypted second DEK in one or more storage locations accessible to the DMS.

A non-transitory computer-readable medium storing code is described. The code may include instructions executable by one or more processors to obtain, by a DMS, backup data associated with one or more computing objects, encrypt, by the DMS, a first intermediary KEK and a second intermediary KEK using a root KEK, encrypt, by the DMS, a first DEK using the first intermediary KEK and a second DEK using the second intermediary KEK, encrypt, by the DMS, a first set of data blocks using the first DEK and a second set of data blocks using the second DEK, the backup data including the first set of data blocks and the second set of data blocks, and store, by the DMS, the encrypted first set of data blocks along with the encrypted first DEK and the encrypted second set of data blocks along with the encrypted second DEK in one or more storage locations accessible to the DMS.

In some examples of the method, apparatus, and non-transitory computer-readable medium described herein may further include operations, features, means, or instructions for encrypting, by the DMS, the root KEK using (e.g., with) a master KEK.

Some examples of the method, apparatus, and non-transitory computer-readable medium described herein may further include operations, features, means, or instructions for encrypting, by the DMS, the root KEK using (e.g., with) an updated master KEK based on a duration since encrypting the root KEK using (e.g., with) the master KEK satisfying a threshold duration.

Some examples of the method, apparatus, and non-transitory computer-readable medium described herein may further include operations, features, means, or instructions for storing, by the DMS in a key management file accessible to the DMS, an indication of a key hierarchy associated with the backup data, the key hierarchy including the master KEK, the root KEK, the first intermediary KEK, the second DEK, the first DEK, and the second DEK.

Some examples of the method, apparatus, and non-transitory computer-readable medium described herein may further include operations, features, means, or instructions for causing display, by the DMS on a user interface associated with an administrator account of the DMS, of an indication of the key hierarchy based on the key management file.

In some examples of the method, apparatus, and non-transitory computer-readable medium described herein, the display indicates associations between data KEKs and intermediary KEKs and respective storage locations of the one or more storage locations.

Some examples of the method, apparatus, and non-transitory computer-readable medium described herein may further include operations, features, means, or instructions for receiving, by the DMS, the master KEK from a computing device associated with a customer account associated with the one or more computing objects.

Some examples of the method, apparatus, and non-transitory computer-readable medium described herein may further include operations, features, means, or instructions for receiving, by the DMS from the computing device after encrypting the root KEK, an updated master KEK, and encrypting, by the DMS, the root KEK with the updated master KEK.

Some examples of the method, apparatus, and non-transitory computer-readable medium described herein may further include operations, features, means, or instructions for obtaining, by the DMS after obtaining the backup data, additional backup data associated with the one or more computing objects, encrypting, by the DMS, a third intermediary KEK using the root KEK, encrypting, by the DMS, a third DEK using the third intermediary KEK, encrypting, by the DMS, a third set of data blocks of the additional backup data using the third DEK, and storing, by the DMS, the encrypted third set of data blocks along with the encrypted third DEK in the one or more storage locations.

Some examples of the method, apparatus, and non-transitory computer-readable medium described herein may further include operations, features, means, or instructions for encrypting, by the DMS, a third DEK using the first intermediary KEK, encrypting, by the DMS, a third set of data blocks using the third DEK, the backup data including the third set of data blocks, and storing, by the DMS, the encrypted third set of data blocks along with the encrypted third DEK in the one or more storage locations.

In some examples of the method, apparatus, and non-transitory computer-readable medium described herein, encrypting the third set of data blocks using the third DEK may be based on a quantity of data blocks of the first set of data blocks satisfying a threshold quantity of data blocks.

In some examples of the method, apparatus, and non-transitory computer-readable medium described herein, encrypting the second DEK using the second intermediary KEK may be based on a quantity of data blocks encrypted in association with the first intermediary KEK satisfying a threshold quantity of data blocks.

In some examples of the method, apparatus, and non-transitory computer-readable medium described herein, encrypting the second DEK using the second intermediary KEK may be based on a duration associated with use of the first intermediary KEK satisfying a threshold duration.

In some examples of the method, apparatus, and non-transitory computer-readable medium described herein, encrypting the first set of data blocks using the first DEK may be based on the first set of data blocks being stored at a first storage location of the one or more storage locations, and encrypting the second set of data blocks using the second DEK may be based on the second set of data blocks being stored at a second storage location of the one or more storage locations.

Some examples of the method, apparatus, and non-transitory computer-readable medium described herein may further include operations, features, means, or instructions for obtaining, by the DMS, a request to retrieve the backup data from the one or more storage locations, retrieving, by the DMS, the encrypted first set of data blocks along with the encrypted first DEK and the encrypted second set of data blocks along with the encrypted second DEK from the one or more storage locations, decrypting, by the DMS, the first intermediary KEK and the second intermediary KEK using the root KEK, decrypting, by the DMS, the first DEK using the decrypted first intermediary KEK and the second DEK using the decrypted second intermediary KEK, and decrypting, by the DMS, the encrypted first set of data blocks using the decrypted first DEK and the encrypted second set of data blocks using the decrypted second DEK to retrieve the backup data.

Some examples of the method, apparatus, and non-transitory computer-readable medium described herein may further include operations, features, means, or instructions for restoring the retrieved backup data to the one or more computing objects or one or more additional computing objects, where obtaining the request includes receiving a request to perform a restore operation for the backup data to the one or more computing objects or the one or more additional computing objects.

A method by an apparatus is described. The method may include obtaining, by a DMS, an indication of an updated master KEK for an encryption key hierarchy associated with backup data managed by the DMS, where, in association with the encryption key hierarchy, a current master KEK encrypts a root KEK, the root KEK encrypts one or more intermediary KEKs, the one or more intermediary KEKs encrypt one or more respective DEKs, and the one or more respective DEKs encrypt one or more respective data blocks of the backup data, where the one or more respective data blocks are stored at one or more storage locations accessible to the DMS, and where a key management file accessible to the DMS indicates the encryption key hierarchy associated with the backup data, encrypting, by the DMS, the root KEK using the updated master KEK, and updating the key management file to indicate that the root KEK is encrypted using the updated master KEK.

An apparatus is described. The apparatus may include one or more memories storing processor executable code, and one or more processors coupled with the one or more memories. The one or more processors may individually or collectively be operable to execute the code to cause the apparatus to obtain, by a DMS, an indication of an updated master KEK for an encryption key hierarchy associated with backup data managed by the DMS, where, in association with the encryption key hierarchy, a current master KEK encrypts a root KEK, the root KEK encrypts one or more intermediary KEKs, the one or more intermediary KEKs encrypt one or more respective DEKs, and the one or more respective DEKs encrypt one or more respective data blocks of the backup data, where the one or more respective data blocks are stored at one or more storage locations accessible to the DMS, and where a key management file accessible to the DMS indicates the encryption key hierarchy associated with the backup data, encrypt, by the DMS, the root KEK using the updated master KEK, and update the key management file to indicate that the root KEK is encrypted using the updated master KEK.

Another apparatus is described. The apparatus may include means for obtaining, by a DMS, an indication of an updated master KEK for an encryption key hierarchy associated with backup data managed by the DMS, where, in association with the encryption key hierarchy, a current master KEK encrypts a root KEK, the root KEK encrypts one or more intermediary KEKs, the one or more intermediary KEKs encrypt one or more respective DEKs, and the one or more respective DEKs encrypt one or more respective data blocks of the backup data, where the one or more respective data blocks are stored at one or more storage locations accessible to the DMS, and where a key management file accessible to the DMS indicates the encryption key hierarchy associated with the backup data, means for encrypting, by the DMS, the root KEK using the updated master KEK, and means for updating the key management file to indicate that the root KEK is encrypted using the updated master KEK.

A non-transitory computer-readable medium storing code is described. The code may include instructions executable by one or more processors to obtain, by a DMS, an indication of an updated master KEK for an encryption key hierarchy associated with backup data managed by the DMS, where, in association with the encryption key hierarchy, a current master KEK encrypts a root KEK, the root KEK encrypts one or more intermediary KEKs, the one or more intermediary KEKs encrypt one or more respective DEKs, and the one or more respective DEKs encrypt one or more respective data blocks of the backup data, where the one or more respective data blocks are stored at one or more storage locations accessible to the DMS, and where a key management file accessible to the DMS indicates the encryption key hierarchy associated with the backup data, encrypt, by the DMS, the root KEK using the updated master KEK, and update the key management file to indicate that the root KEK is encrypted using the updated master KEK.

Some examples of the method, apparatus, and non-transitory computer-readable medium described herein may further include operations, features, means, or instructions for storing, by the DMS, the one or more respective data blocks along with the one or more respective DEKs at the one or more storage locations, and activating, by the DMS, an immutability lock for at least one storage location of the one or more storage locations.

In some examples of the method, apparatus, and non-transitory computer-readable medium described herein, operations, features, means, or instructions for encrypting the root KEK may include operations, features, means, or instructions for encrypting the root KEK while the immutability lock for the at least one storage location may be activated.

Some examples of the method, apparatus, and non-transitory computer-readable medium described herein may further include operations, features, means, or instructions for updating, by the DMS, a secondary key management file based on updating the key management file, where the key management file may be accessible to a first customer account with read/write permissions for the backup data, and where the secondary key management file may be accessible to a second customer account with read-only permissions for the backup data.

In some examples of the method, apparatus, and non-transitory computer-readable medium described herein, operations, features, means, or instructions for obtaining the indication of the updated master KEK may include operations, features, means, or instructions for receiving, by the DMS, the updated master KEK from a computing device that may be associated with a customer account associated with the backup data.

In some examples of the method, apparatus, and non-transitory computer-readable medium described herein, obtaining the indication of the updated master KEK may include operations, features, means, or instructions for obtaining the updated master KEK from a key management service.

In some examples of the method, apparatus, and non-transitory computer-readable medium described herein, obtaining the indication of the updated master KEK may be based on a duration since reception of the current master KEK satisfying a threshold duration.

Some examples of the method, apparatus, and non-transitory computer-readable medium described herein may further include operations, features, means, or instructions for obtaining, by the DMS, a request to retrieve the backup data from the one or more storage locations, retrieving, by the DMS, the encrypted one or more respective data blocks of the backup data, decrypting, by the DMS, based on the encryption key hierarchy indicated by the key management file, the one or more respective DEKs, and decrypting, by the DMS, the encrypted one or more respective data blocks using the decrypted one or more respective DEKs to extract the one or more respective data blocks.

Some examples of the method, apparatus, and non-transitory computer-readable medium described herein may further include operations, features, means, or instructions for restoring the retrieved backup data to one or more computing objects, where obtaining the request includes receiving a request to perform a restore operation for the backup data to the one or more computing objects.

In some examples of the method, apparatus, and non-transitory computer-readable medium described herein, operations, features, means, or instructions for obtaining the request to retrieve the backup data may include operations, features, means, or instructions for receiving the request from a computing device associated with a customer account with read-only permissions for the backup data, where the decrypting may be based on the request including an indication of the updated master KEK.

Some examples of the method, apparatus, and non-transitory computer-readable medium described herein may further include operations, features, means, or instructions for generating, by the DMS and based on obtaining the indication of the updated master KEK, a backup key management file that indicates the encryption key hierarchy including the current master KEK prior to encrypting the root KEK using the updated master KEK.

Some examples of the method, apparatus, and non-transitory computer-readable medium described herein may further include operations, features, means, or instructions for generating, based on encrypting the one or more respective data blocks using the one or more respective DEKs, the key management file.

In some examples of the method, apparatus, and non-transitory computer-readable medium described herein, a first DEK encrypts one or more first data blocks of the backup data, a second DEK encrypts one or more second data blocks of the backup data based on a quantity of data blocks of the one or more first data blocks satisfying a threshold, and a first intermediary KEK of the one or more intermediary KEKs encrypts both the first DEK and the second DEK.

In some examples of the method, apparatus, and non-transitory computer-readable medium described herein, a first DEK encrypts one or more first data blocks of the backup data based on the one or more first data blocks being stored at a first storage location of the one or more storage locations, a second DEK encrypts one or more second data blocks of the backup data based on the one or more second data blocks being stored at a second storage location of the one or more storage locations and a first intermediary KEK of the one or more intermediary KEKs encrypts both the first DEK and the second DEK.

In some examples of the method, apparatus, and non-transitory computer-readable medium described herein, a first intermediary KEK of the one or more intermediary KEKs encrypts one or more first DEKs and a second intermediary KEK of the one or more intermediary KEKs encrypts one or more second DEKs based on a quantity of data blocks encrypted by the one or more first DEKs satisfying a threshold.

In some examples of the method, apparatus, and non-transitory computer-readable medium described herein, a first intermediary KEK of the one or more intermediary KEKs encrypts one or more first DEKs and a second intermediary KEK of the one or more intermediary KEKs encrypts one or more second DEKs based on a duration associated with use of the first intermediary KEK satisfying a threshold duration.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
obtaining, by a data management system (DMS), backup data associated with one or more computing objects;
encrypting, by the DMS, a first intermediary key encryption key and a second intermediary key encryption key using a root key encryption key;
encrypting, by the DMS, a first data encryption key using the first intermediary key encryption key and a second data encryption key using the second intermediary key encryption key;
encrypting, by the DMS, a first set of data blocks using the first data encryption key and a second set of data blocks using the second data encryption key, the backup data comprising the first set of data blocks and the second set of data blocks; and
storing, by the DMS, the encrypted first set of data blocks along with the encrypted first data encryption key and the encrypted second set of data blocks along with the encrypted second data encryption key in one or more storage locations accessible to the DMS.

2. The method of claim 1, further comprising:
encrypting, by the DMS, the root key encryption key using a master key encryption key.

3. The method of claim 2, further comprising:
encrypting, by the DMS, the root key encryption key using an updated master key encryption key based at least in part on a duration since encrypting the root key encryption key using the master key encryption key satisfying a threshold duration.

4. The method of claim 2, further comprising:
storing, by the DMS in a key management file accessible to the DMS, an indication of a key hierarchy associated with the backup data, the key hierarchy comprising the master key encryption key, the root key encryption key, the first intermediary key encryption key, the second data encryption key, the first data encryption key, and the second data encryption key.

5. The method of claim 4, further comprising:
causing display, by the DMS on a user interface associated with an administrator account of the DMS, of an indication of the key hierarchy based at least in part on the key management file.

6. The method of claim 5, wherein the display indicates associations between data key encryption keys and intermediary key encryption keys and respective storage locations of the one or more storage locations.

7. The method of claim 2, further comprising:
receiving, by the DMS, the master key encryption key from a computing device associated with a customer account associated with the one or more computing objects.

8. The method of claim 7, further comprising:
receiving, by the DMS from the computing device after encrypting the root key encryption key, an updated master key encryption key; and
encrypting, by the DMS, the root key encryption key using the updated master key encryption key.

9. The method of claim 1, further comprising:
obtaining, by the DMS after obtaining the backup data, additional backup data associated with the one or more computing objects;
encrypting, by the DMS, a third intermediary key encryption key using the root key encryption key;
encrypting, by the DMS, a third data encryption key using the third intermediary key encryption key;
encrypting, by the DMS, a third set of data blocks of the additional backup data using the third data encryption key; and
storing, by the DMS, the encrypted third set of data blocks along with the encrypted third data encryption key in the one or more storage locations.

10. The method of claim 1, further comprising:
encrypting, by the DMS, a third data encryption key using the first intermediary key encryption key;
encrypting, by the DMS, a third set of data blocks using the third data encryption key, the backup data including the third set of data blocks; and
storing, by the DMS, the encrypted third set of data blocks along with the encrypted third data encryption key in the one or more storage locations.

11. The method of claim 10, wherein encrypting the third set of data blocks using the third data encryption key is based at least in part on a quantity of data blocks of the first set of data blocks satisfying a threshold quantity of data blocks.

12. The method of claim 1, wherein encrypting the second data encryption key using the second intermediary key encryption key is based at least in part on a quantity of data blocks encrypted in association with the first intermediary key encryption key satisfying a threshold quantity of data blocks.

13. The method of claim 1, wherein encrypting the second data encryption key using the second intermediary key encryption key is based at least in part on a duration associated with use of the first intermediary key encryption key satisfying a threshold duration.

14. The method of claim 1, wherein:
encrypting the first set of data blocks using the first data encryption key is based at least in part on the first set of data blocks being stored at a first storage location of the one or more storage locations, and
encrypting the second set of data blocks using the second data encryption key is based at least in part on the second set of data blocks being stored at a second storage location of the one or more storage locations.

15. The method of claim 1, further comprising:
obtaining, by the DMS, a request to retrieve the backup data from the one or more storage locations;
retrieving, by the DMS, the encrypted first set of data blocks along with the encrypted first data encryption key and the encrypted second set of data blocks along with the encrypted second data encryption key from the one or more storage locations;
decrypting, by the DMS, the first intermediary key encryption key and the second intermediary key encryption key using the root key encryption key;
decrypting, by the DMS, the first data encryption key using the decrypted first intermediary key encryption key and the second data encryption key using the decrypted second intermediary key encryption key; and
decrypting, by the DMS, the encrypted first set of data blocks using the decrypted first data encryption key and the encrypted second set of data blocks using the decrypted second data encryption key to retrieve the backup data.

16. The method of claim 15, further comprising:
restoring the retrieved backup data to the one or more computing objects or one or more additional computing objects, wherein obtaining the request comprises receiving a request to perform a restore operation for the backup data to the one or more computing objects or the one or more additional computing objects.

17. An apparatus, comprising:
one or more memories storing processor-executable code; and
one or more processors coupled with the one or more memories and individually or collectively operable to execute the code to cause the apparatus to:
obtain, by a data management system (DMS), backup data associated with one or more computing objects;
encrypt, by the DMS, a first intermediary key encryption key and a second intermediary key encryption key using a root key encryption key;
encrypt, by the DMS, a first data encryption key using the first intermediary key encryption key and a second data encryption key using the second intermediary key encryption key;
encrypt, by the DMS, a first set of data blocks using the first data encryption key and a second set of data blocks using the second data encryption key, the backup data comprising the first set of data blocks and the second set of data blocks; and
store, by the DMS, the encrypted first set of data blocks along with the encrypted first data encryption key and the encrypted second set of data blocks along with the encrypted second data encryption key in one or more storage locations accessible to the DMS.

18. The apparatus of claim 17, wherein the one or more processors are individually or collectively further operable to execute the code to cause the apparatus to:
encrypt, by the DMS, the root key encryption key using a master key encryption key.

19. The apparatus of claim 18, wherein the one or more processors are individually or collectively further operable to execute the code to cause the apparatus to:
encrypt, by the DMS, the root key encryption key using an update master key encryption key based at least in part on a duration since encrypting the root key encryption key using the master key encryption key satisfying a threshold duration.

20. A non-transitory computer-readable medium storing code, the code comprising instructions executable by one or more processors to:
obtain, by a data management system (DMS), backup data associated with one or more computing objects;
encrypt, by the DMS, a first intermediary key encryption key and a second intermediary key encryption key using a root key encryption key;
encrypt, by the DMS, a first data encryption key using the first intermediary key encryption key and a second data encryption key using the second intermediary key encryption key;
encrypt, by the DMS, a first set of data blocks using the first data encryption key and a second set of data blocks using the second data encryption key, the backup data comprising the first set of data blocks and the second set of data blocks; and
store, by the DMS, the encrypted first set of data blocks along with the encrypted first data encryption key and the encrypted second set of data blocks along with the encrypted second data encryption key in one or more storage locations accessible to the DMS.
